(19) United States
(12) Patent Application Publication
(10) Pub. No.: US 2018/0039197 A1
(43) Pub. Date: Feb. 8, 2018

(54) IMAGE FORMING METHOD

(71) Applicant: Mitsubishi Chemical Corporation, Tokyo (JP)

(72) Inventor: Tadashi MIZUNO, Niigata (JP)

(73) Assignee: Mitsubishi Chemical Corporation, Tokyo (JP)

(21) Appl. No.: 15/719,654

(22) Filed: Sep. 29, 2017

Related U.S. Application Data
(63) Continuation-in-part of application No. PCT/JP2016/060080, filed on Mar. 29, 2016.

(30) Foreign Application Priority Data
Mar. 30, 2015 (JP) 2015-069288

(51) Int. Cl. G03G 15/01; G03G 9/08; G03G 9/093; G03G 9/113; G03G 9/087

(52) U.S. Cl. CPC G03G 9/1136; G03G 9/0819; G03G 9/08711; G03G 9/09392; G03G 9/09364; G03G 9/09321; G03G 9/0827; G03G 21/1807; G03G 15/0105; G03G 21/0005

(57) ABSTRACT

The present invention relates to an image forming method in which an electrophotographic cartridge is disposed in at least four-color tandem with respect to a transfer material transporting body, in which, in a case where a fixing step side of the transfer material transporting body is set as a downstream side, and a cleaning step side of the transfer material transporting body is set as an upstream side, a total amount of use amount of specific external additives contained in the toner for each of the color electrophotographic cartridges is adjusted to a specific amount, and a specific amount of a specific external additive is used for toner provided in the electrophotographic cartridge on the most downstream side.

### TECHNICAL FIELD

The present invention relates to an image forming method used in electrophotography and electrostatography.

### BACKGROUND ART

In recent years, the use of the image forming apparatus such as an electrophotographic copying machine has expanded, and market demand for image quality has required much higher standards. Even in documents or the like for office use, the kind of character's hieroglyph is more abundant and finer even at the time of output in accordance with development of a mapping technology and a latent image forming technology at the time of input, and the reproducibility of an original image with extremely high image quality and little defect or blurring in a printed image has been required as presentation software is spread and developed.

From the above situation, an intermediate transfer method in which a plurality of image forming units having a photosensitive drum or the like for each color are provided as an electrophotographic and digital type full-color image forming apparatus, and a toner image for each color formed on the photosensitive drum is sequentially superimposed and transferred onto a transfer material such as an intermediate transfer belt has been widely employed.

In the image forming apparatus including a transfer material transporting belt, the transfer material transporting belt is strained by fog toner and toner scattered from a photosensitive drum. For this reason, a cleaning apparatus including a cleaning blade as a cleaning member is provided in order to clean dirt on the transfer material transporting belt, and the cleaning blade is brought into contact with a transporting belt by a predetermined pressure so as to scrape and clean a surface of the transfer material transporting belt.

For this reason, many proposals have been made as cleaning means of the intermediate transfer member, and as disclosed in JP-A-2004-053956 (PTL 1), generally, the cleaning properties are improved by adjusting the properties of a rubber material of the cleaning blade.

On the other hand, from the viewpoint of improvement of development efficiency and improvement of dot reproducibility with respect to toner, sphericalization and small particle size of the toner have been progressing. Furthermore, from the viewpoint of improvement of oil coating unevenness in fixing and miniaturization of a fixing device, the demand for oilless toner has been increased and commercialized.

As one typical production method of toner, a pulverization method in which various materials such as a binder resin, a coloring agent, and a charge control agent are melted, mixed, pulverized, and classified so as to form fine powder is exemplified, and is widely employed in general regardless of color or monochrome, and various developing methods from the view point that high quality of toner can be obtained in a relatively simple manner.

In addition, in order to respond to the recent demand for higher speed and higher image quality with respect to electrophotography, research and development of polymerized toner have been advanced. The polymerized toner is easy to control a particle size as compared with pulverized toner, and thus it is possible to obtain toner base particles having a small particle size suitable for high image quality.

Furthermore, since toner can be encapsulated by grain structure control, there is an advantage in that toner excellent in heat resistance and low temperature fixability can be obtained.

Various studies have been conducted so as to mount toner size-reduced in the image forming apparatus as described above and obtain stable image quality without an image defect.

For example, a technology of imparting charge stability has been known with a technology of externally adding a small-sized silica particle having an average primary particle size in a range of 7 to 35 nm in order to obtain appropriate chargeability and transferability of the toner, as disclosed in JP-A-2001-109185 (PTL 2), and a technology of externally adding a large-sized silica particle having an average primary particle size in a range of 50 to 300 nm in order to secure durability, as disclosed in JP-A-2012-27142 (PTL 3), JP-A-2001-66820 (PTL 4), and JP-A-2002-108001 (PTL 5).

Although these techniques provide a certain effect from the viewpoint of obtaining toner consumption and image density, the cleaning properties of the transfer material transporting belt are not taken into consideration, and as a result of studies of the present inventor, it turns out that the performance is insufficient.

### CITATION LIST

### Patent Literature

[PTL 1] JP-A-2004-053956

[PTL 2] JP-A-2001-109185

[PTL 3] JP-A-2012-27142

[PTL 4] JP-A-2001-66820

[PTL 5] JP-A-2002-108001

[PTL 6] JP-A-2014-191215

### SUMMARY OF INVENTION

### Technical Problem

In JP-A-2014-191215 (PTL 6), the focusing on the cleaning properties of the transfer material transporting belt, a technology of improving the cleaning properties by adding a specific amount of silicone oil treated silica and higher fatty acid metal salt particles which have a specific volume average particle size is well-known.

With the technology disclosed in JP-A-2014-191215 (PTL 6), a certain effect of the cleaning properties in the transfer material transporting belt can be obtained, but further improvement of the cleaning properties has been required in transfer material transporting belt with many usage histories.

In order to improve the cleaning properties of the transfer material transporting belt, it is important to scratch a lot of waste toner remaining on the belt after a secondary transfer (transfer to a recording medium) by the cleaning blade installed on the belt, and to smoothly transport the waste toner to a waste toner collecting unit. Accordingly, due to excessive deposition of toner or abrasion of the blade by toner, scratch resistance and transportability in the vicinity of the blade of the waste toner are insufficient, and the waste toner remaining on the belt is likely to slip through the blade.

As described above, an image forming method in which the cleaning properties of the transfer material transporting belt, the image density, and the toner consumption amount can be good at the same time while appropriately controlling the fluidity and chargeability of the toner is not provided yet.

### Solution to Problem

In order to solve the above-described problem, the present inventor conducted extensive studies, and as a result thereof, it was found that the problem can be solved by using an image forming method. In the image forming method in which an electrophotographic cartridge disposed in at least four-color tandem with respect to a transfer material transporting body, in a case where a fixing step side of the transfer material transporting body is set as a downstream side, and a cleaning step side of the transfer material transporting body is set as an upstream side, a total amount of use amount of specific external additives contained in the toner for each of the color electrophotographic cartridges is adjusted to a specific amount, and a specific amount of a specific external additive is used for toner provided in the electrophotographic cartridge on the most downstream side.

That is, the summary of the present invention is as follows [1] to [8].

[1] An image forming method comprising:

a developing step of using an electrophotographic cartridge equipped with an electrophotographic photoreceptor and toner for developing an electrostatic charge image, and carrying a toner image on the electrophotographic photoreceptor with an electrostatic latent image;

a transfer step of transferring the toner image on the electrophotographic photoreceptor to a transfer material transporting body;

a fixing step of fixing the toner image transferred on the transfer material transporting body to a recording medium; and

a cleaning step of removing the toner remaining in the transfer step from the surface of the transfer material transporting body by a cleaning member for a transfer material transporting body,

wherein the electrophotographic cartridge is disposed in at least four-color tandem with respect to the transfer material transporting body, and

in the transfer step, in a case where the fixing step side of the transfer material transporting body is set as a downstream side, and the cleaning step side of the transfer material transporting body is set as an upstream side, and the electrophotographic cartridge disposed in the four-color tandem satisfies the following (A) to (C):

(A) each color toner provided in an electrophotographic cartridge disposed in a four-color tandem is toner comprising: toner base particles which contain at least a binder resin, a coloring agent and wax; and an external additive, and the toner contains silica particles as the external additive,

(B) the total of four colors of the content of the silica particles contained in each color toner is in a range of 9.0 parts by mass to 12.0 parts by mass with respect to 100 parts by mass of the toner base particles, and the content of the silica particles contained in each color toner is not all the same in four colors, and

(C) the total content of the silica particles in the toner provided in an electrophotographic cartridge disposed on the most downstream side in the transfer step is in a range of 2.3 parts by mass to 3.0 parts by mass with respect to 100 parts by mass of the toner base particles.

[2] The image forming method according to [1], wherein in the (A), the toner contains silica particles a having a specific surface area in a range of 10 m²/g to 45 m²/g and silica particles b having a specific surface area in a range of 100 m²/g to 160 m²/g.
[3] The image forming method according to [1] or [2], wherein the content of the silica particles in the toner provided in an electrophotographic cartridge disposed on the most downstream side is smaller than the content of the silica particles in the each color toner provided in at least two-color of electrophotographic cartridges other than the electrophotographic cartridge disposed on the most downstream side.
[4] The image forming method according to [1] or [2], wherein the content of the silica particles in the toner provided in an electrophotographic cartridge disposed on the most downstream side is smallest, compared with the content of the silica particles in the each color toner provided in the electrophotographic cartridges other than the electrophotographic cartridge disposed on the most downstream side.
[5] The image forming method according to [1] or [2], wherein a ratio of the content X of the silica particles in the toner provided in an electrophotographic cartridge disposed on the most downstream side and the total sum of content Y of the silica particles in the each color toner provided in the electrophotographic cartridges other than the electrophotographic cartridge disposed on the most downstream side (X/Y) is 0.250 to 0.330.
[6] The image forming method according to any one of [2] to [5], wherein the silica particles a are surface-treated with polydimethyl siloxane.
[7] The image forming method according to any one of [2] to [6], wherein the silica particles a before being surface-treated are dry silica particles.
[8] The image forming method according to any one of [2] to [7], wherein each toner provided in an electrophotographic cartridge other than the electrophotographic cartridge disposed on the most downstream side in the transfer step, contains the silica particles a in a range of 0.50 parts by mass to 2.0 parts by mass, and the silica particles b in a range of 0.20 parts by mass to 2.0 parts by mass, with respect to 100 parts by mass of the toner base particles.

### Advantageous Effects of Invention

According to the present invention, it is possible to provide an image forming method in which image density is good and toner consumption is excellent without a cleaning defect of a transfer material transporting belt or the like.

### BRIEF DESCRIPTION OF DRAWINGS

FIG. 1 is a diagram illustrating a main configuration of an image forming apparatus having a transfer material transporting body.

FIG. 2 is a diagram illustrating a main configuration of an electrophotographic cartridge used for an image forming apparatus.

### DESCRIPTION OF EMBODIMENTS

Hereinafter, the present invention will be described in detail. However, the present invention is not limited to the following embodiments, and can be arbitrarily modified and implemented without departing from the gist of the present invention.

### <1. Electrophotographic Cartridge Used in Image Forming Method of the Present Invention>

An electrophotographic cartridge disposed in a four-color tandem used in an image forming method of the present invention contains toner having toner base particles which contain at least a binder resin, a coloring agent, and wax, and an external additive toner. The electrophotographic cartridge satisfies (A) to (C).

Note that, a fixing step side of the transfer material transporting body is set as a downstream side, and a cleaning step side of the transfer material transporting body is set as an upstream side.

(A) Each color toner provided in an electrophotographic cartridge disposed in a four-color tandem is toner having toner base particles which contain at least a binder resin, a coloring agent, and wax, and an external additive, and the toner has silica particles as the external additive.
(B) The total of four colors of the content of the silica particles contained in each color toner is in a range of 9.0 parts by mass to 12.0 parts by mass with respect to 100 parts by mass of the toner base particles, and the content of the silica particles contained in each color toner is not all the same in four colors.
(C) The total content of the silica particles in the toner provided in an electrophotographic cartridge disposed on the most downstream side in a transfer step is in a range of 2.3 parts by mass to 3.0 parts by mass with respect to 100 parts by mass of the toner base particles.

### <1-1. Regarding Condition (A) of the Present Invention>

Each color toner provided in the electrophotographic cartridge disposed in the four-color tandem of the present invention has toner base particles which contain at least a binder resin, a coloring agent, and wax, and an external additive, and the toner has silica particles as the external additive.

It is preferable that the silica particle the toner has silica particles having a specific surface area in a range of 10 m²/g to 45 m²/g and silica particles b having a specific surface area in a range of 100 m²/g to 160 m²/g.

The specific surface area of the silica particles a is preferably equal to or less than 40 m²/g, and is particularly preferably equal to or less than 35 m²/g. On the other hand, the specific surface area of the silica particles a is further preferably equal to or greater than 15 m²/g.

When the specific surface area of the silica particles a is excessively large, not only sufficient cleaning effect of the transfer material transporting belt cannot be obtained, but also burial into the surface of the base particles become conspicuous toner, and thus there is a possibility that the fluidity is deteriorated at the end of long-term printing, and fog or the like occurs. On the other hand, when the specific surface area of the silica particles a is excessively small, an imparting effect of fluidity is small, solid followability is deteriorated or it is hard to adhere to toner base particles, and member contamination due to desorption occurs in some cases.

The specific surface area of the silica particles a is measured by the method described in Examples.

The specific surface area of the silica particles b is preferably equal to or greater than 102 m²/g, and is particularly preferably equal to or greater than 104 m²/g. On the other hand, the specific surface area of the silica particles b is further preferably equal to or less than 150 m²/g.

When the specific surface area of the silica particles b is excessively small, the imparting effect of fluidity is small, and thus the solid followability is deteriorated, and thereby fog occurs without improving expected charging amount in some cases. On the other hand, when the specific surface area of the silica particles b is excessively large, there is possibility that the external additives are aggregated to each other, and thus desired fluidity cannot be obtained and a cleaning problem of the transfer material transporting belt occurs in some cases.

The specific surface area of the silica particles b is measured by the method described in Examples.

Specific examples of the silica particles a having the specific surface area in a range of 10 m²/g to 45 m²/g include RY50, RY51, RY40S, RX40S, VPSY110, and VPSX110 (which are all produced by Nippon Aerosil Co., Ltd.), X24-9163A and X24(9600A-100) (which are all produced by Shin-Etsu Chemical Co., Ltd.), and TGC-243 (produced by Cabot Corporation).

Specific examples of the silica particles b having the specific surface area 100 m²/g to 160 m²/g include RY200L (produced by Nippon Aerosil Co., Ltd.) and H30TD (produced by Wacker Chemical Corporation).

### <1-2. Regarding Condition (B) of the Present Invention>

It is necessary that the total of four colors of the content of the silica particles contained in each color toner is in a range of 9.0 parts by mass to 12.0 parts by mass respect to 100 parts by mass of the toner base particles, and the content of the silica particles contained in each color toner is not all the same in four colors. In addition, the total of four colors of the content of the silica particles is preferably equal to or greater than 9.50 parts by mass, and is particularly preferably equal to or greater than 9.75 parts by mass. On the other hand, the total of four colors of the content of the silica particles is preferably equal to or less than 11.75 parts by mass, and is particularly preferably equal to or less than 11.50 parts by mass.

When the total content of the silica particles is excessively small, there is a possibility that sufficient chargeability cannot be obtained, the image density is not stable, not only the density difference between colors increases but also a desired fluidity cannot be obtained, and thereby the cleaning problem of the transfer material transporting belt occurs. On the other hand, when the total content of the silica particles is excessively large, there is a possibility that as the distribution of the charging amount is spread, the image density is not stable, and not only the density difference between colors is increased but also member contamination due to the desorption from toner base particles occurs. The specific surface area of the silica particles is measured by the method described in Examples.

### <1-3. Regarding Condition (C) of the Present Invention>

In the image forming method of the present invention, it is necessary that the total content of the silica particles in the toner provided in an electrophotographic cartridge disposed on the most downstream side in a transfer step is in a range of 2.3 parts by mass to 3.0 parts by mass with respect to 100 parts by mass of the toner base particles. The content of the silica particles in the toner provided in an electrophotographic cartridge disposed on the most downstream side is adjusted, and it is not necessary that the content of the silica particles is all the same in four colors. It is preferable that the content of the silica particles in the toner provided in an electrophotographic cartridge disposed on the most downstream side is smaller than the content of the silica particles in the each color toner provided in at least two-color of electrophotographic cartridges other than the electrophotographic cartridge disposed on the most downstream side. It is more preferable that the content of the silica particles in the toner provided in an electrophotographic cartridge disposed on the most downstream side is smallest, compared with the content of the silica particles in the each color toner provided in the electrophotographic cartridges other than the electrophotographic cartridge disposed on the most downstream side. Also, it is preferable that a ratio of the content X of the silica particles in the toner provided in an electrophotographic cartridge disposed on the most downstream side and the total sum of content Y of the silica particles in the each color toner provided in the electrophotographic cartridges other than the electrophotographic cartridge disposed on the most downstream side (X/Y) is 0.250 to 0.330. Since the electrophotographic cartridge disposed on the most downstream side is a cartridge that is the closest to a paper, a dirt of member due to a detachment of silica remarkably readily affects an image as an image defect. Thus, an influence of a dirt of member can be smaller, and image having an excellent image density can be obtained by setting the content of the silica particles in the toner provided in an electrophotographic cartridge disposed on the most downstream side to a smaller content than that in the other colors, and securely setting the total content of silica particles in all colors to a certain content of silica particles.

In addition, the total amount of the silica particles added is preferably equal to or greater than 2.35 parts by mass, and is particularly preferably equal to or greater than 2.40 parts by mass. On the other hand, the total amount of the silica particles added is preferably equal to or less than 2.95 parts by mass, is further preferably equal to or less than 2.90 parts by mass, is still further preferably equal to or less than 2.85 parts by mass, and is particularly preferably equal to or less than 2.80 parts by mass.

When the total amount of the silica particles added is excessively small, there is a possibility that the desired fluidity cannot be obtained, and the cleaning problem occurs. On the other hand, the total amount of the silica particles added is excessively large, member contamination due to the desorption from toner base particles occurs.

<1-4. Regarding Surface Treatment Agent of Silica Particles a>

A surface treatment agent of the silica particles a used in the present invention is not particularly limited as long as long as the effect of the present invention is not significantly impaired, but it has been found that the effect of the present invention can be more remarkably obtained by surface treating silica particles a with polydimethyl siloxane as the surface treatment agent.

Other than the polydimethyl siloxane treatment, a hexamethyl disilazane treatment and a double treatment of an octylsilane treatment and the hexamethyl disilazane treatment can be used.

Specific examples of the silica particles a for the polydimethyl siloxane treatment include RY50, RY51, RY40S, and VPSY110 (which are all produced by Nippon Aerosil Co., Ltd).

Specific examples of the silica particles a for hexamethyl disilazane treatment include RX40S and VPSX110 (which are all produced by Nippon Aerosil Co., Ltd.), and X24-9163A and X24 (9600A-100) (which are all produced by Shin-Etsu Chemical Co., Ltd).

Specific examples of the silica particles a for the double treatment of the octylsilane treatment and the hexamethyl disilazane treatment include TGC-243 (produced by Cabot Corporation).

<1-5. Regarding Method of Producing Silica Particles Before Surface Treatment of Silica Particles a>

A method for producing the silica particles a used in the present invention is not particularly limited, and the silica particles a can be prepared by a known method; however, it has been found that the effect of the present invention can be more remarkably by dry silica particles obtained by a dry method. As used herein, the dry method refers to the entire production method by reaction in a gas phase such as flame hydrolysis of a silicon compound, oxidation by a flame combustion method, or a combination of these reactions.

In addition to the dry method, there is a wet method as another method of producing silica. Examples of the method of producing silica particle includes a gel method of producing silica particles by a neutralization reaction of a sodium silicate solution and a sulfuric acid, a precipitation method, and a sol-gel method of producing silica particles by hydrolyzing an alkoxide of silicon such as tetramethoxysilane or tetraethoxysilane in an acidic or alkaline water-containing organic solvent. Although the cause is unknown, the silica particle obtained by the dry method is not clearly fallen in the depression of the base particles with respect to the silica particle obtained by the wet method, and the cleaning properties of the transfer material transporting belt are satisfactory.

Specific examples of the dry silica particles a produced by the dry method include RY50, RY51, RY40S, and RX40S (which are all produced by Nippon Aerosil Co., Ltd.). Specific examples of the silica particles a produced by the wet method include VPSY110 and VPSX110 (which are all produced by Nippon Aerosil Co., Ltd.), X24-9163A and X24 (9600A-100) (which are all produced by Shin-Etsu Chemical Co., Ltd.), and TGC-243 (produced by Cabot Corporation).

<1-6. Total Content of Silica Particles a of Toner Provided in Electrophotographic Cartridge Other than Electrophotographic Cartridge Disposed on the Most Downstream Side in Transfer Step>

In the image forming method of the present invention, the total content of the silica particles a of the toner provided in an electrophotographic cartridge other than the electrophotographic cartridge disposed on the most downstream side in the transfer step, is typically equal to or less than 2.0 parts by mass, is preferably equal to or less than 1.90 parts by mass, and is particularly preferably equal to or less than 1.80 parts by mass, with respect to 100 parts by mass of the toner base particles. In addition, it is typically equal to or greater than 0.50 parts by mass, is preferably equal to or greater than 0.75 parts by mass, and is particularly preferably equal to or greater than 1.00 parts by mass, with respect to 100 parts by mass of the toner base particles.

When the amount of the silica particles a added is excessively small, there is a possibility that the effect of suppressing excessive charging cannot be sufficiently obtained, and fog occurs. On the other hand, when the amount of the silica particles a added is excessively large, member contamination due to desorption from the toner base particles occurs in some cases.

<1-7. Total Content of Silica Particles b of Toner Provided in Electrophotographic Cartridge Other than Electrophotographic Cartridge Disposed on the Most Downstream Side in Transfer Step>

In the image forming method of the present invention, the total content of the silica particles b of the toner provided in an electrophotographic cartridge other than the electrophotographic cartridge disposed on the most downstream side in the transfer step, is typically equal to or less than 2.0 parts by mass, is preferably equal to or less than 1.90 parts by mass, and is particularly preferably equal to or less than 1.80 parts by mass, with respect to 100 parts by mass of the toner base particles. In addition, it is typically equal to or greater than 0.20 parts by mass, is preferably equal to or greater than 0.30 parts by mass, and is particularly preferably equal to or greater than 0.40 parts by mass, with respect to 100 parts by mass of the toner base particles.

When the amount of the silica particles b added is excessively small, the sufficient fluidity cannot be obtained and solid blurring occurs in some cases. On the other hand, when the amount of the silica particles b added is excessively large, desorption from the toner base particles becomes conspicuous so that member contamination may occur or fog may occur as the distribution of the toner charging amount is spread.

<Regarding External Additive c>

The toner used in the present invention can obtain a remarkable effect of the present invention by further having, as external additives, a titanium oxide particle as an external additive c which is different from the aforementioned silica particles a and silica particles b.

The external additive c preferably has a titanium oxide particle having the specific surface area of equal to or greater than 60 m²/g, and the amount of the titanium oxide particle added is further preferably equal to or less than 0.28 parts by mass with respect to 100 parts by mass of the toner base particles. When the external additive c is added to the toner base particle, the charging of the toner becomes uniform and the image density can be stabilized. The charging amount is measured by the method described in Examples.

The specific surface area of the titanium oxide particle is not particularly limited as long as the effect of the present invention is not significantly impaired, and is typically equal to or greater than 60 m²/g, is preferably equal to or greater than 65 m²/g, and is particularly preferably equal to or greater than 70 m²/g. When the specific surface area is excessively small, the titanium oxide particle is likely to be desorbed from the toner base particle, and thereby member contamination occurs in some cases. Specific examples of such a titanium oxide particle include JMT150AO and SMT150IB (which are all produced by TAYCA CORPORATION).

The specific surface area of the external additive c is measured by the method described in Examples.

The amount of the external additive c added is not particularly limited as long as the effect of the present invention is not significantly impaired, and is typically equal to or less than 0.28 parts by mass, is preferably equal to or less than 0.26 parts by mass, and includes s particularly preferably equal to or less than 0.24 parts by mass, with respect to 100 parts by mass of the toner base particles. In addition, the amount of the external additive c added is typically equal to or greater than 0.05 parts by mass, and is further preferably equal to or greater than 0.10 parts by mass.

When the amount of the external additive c added is excessively large, there is possibility that desired fluidity cannot be obtained and a cleaning problem of the transfer material transporting belt occurs in some cases. When the amount of the external additive c added is excessively small, the toner is charged up and white spots and the like occur in some cases.

### <External Addition Step>

The toner used in the present invention can be obtained by externally adding at least the aforementioned silica particles and titanium oxide to the surface of the toner base particle, but as long as the effect of the present invention is not significantly impaired, particles which are known as other external additives may be used in combination and added to the toner base particles so as to be adhered or fixed to the surface of the toner base particle.

Regarding particles other than the above-described silica particles and titanium oxide, examples of the inorganic particle include aluminum oxide (alumina), zinc oxide, tin oxide, barium titanate, strontium titanate, hydrotalcite, and a composite oxide particle. In addition, examples of the organic particle include an organic resin particle such as a methacrylic acid ester polymer particle, an acrylic acid ester polymer particle, a styrene-methacrylic acid ester copolymer particle, and a styrene-acrylic acid ester copolymer particle.

The mixing ratio of the silica particle, the titanium oxide, and other particles is not particularly limited, and the use amount of the entire external additives formed of the silica particle, the titanium oxide, and other particles is not particularly limited. Typically, the use amount of the entire external additives is equal to or greater than 0.6 parts by mass, and is preferably equal to or greater than 0.7 parts by mass, with respect to 100 parts by mass of the toner base particle.

In addition, typically, the use amount of the entire external additives is equal to or less than 3.7 parts by mass, and is preferably equal to or less than 3.6 parts by mass with respect to 100 parts by mass of the toner base particle. When the use amount is excessively small, burial of external additives into the surface of the base particle becomes conspicuous and fog may be deteriorated in some cases. On the other hand, when the use amount is excessively large, the cleaning blade falls out by excessive fluidity, and thus an image defect may be caused.

Regarding the above-described other particles, the order of adhesion or fixing to the surface of the toner base particles is not particularly limited, but it may be used in combination with the above-described silica particle, titanium oxide, and other particles, or may be separately added without being used together.

In the present invention, a method of adhering or fixing of the above-described silica particle, titanium oxide, and other particles to the surface of the toner base particles is not particularly limited, and generally, a mixing machine used in the producing of the toner can be used. Specifically, stirring and mixing can be performed by using a mixing machine such as a Henschel mixer, a V-type blender, a Loedige mixer, and a Q-mixer.

### <Other Configuration and Producing Method of Toner Base Particle>

The volume median diameter of the toner base particle used in the present invention is not particularly limited, and typically, is equal to or greater than 2.5 is preferably equal to or greater than 3.0 μm, and is further preferably equal to or greater than 3.5 μm. In addition, the volume median diameter of the toner base particle is typically equal to or less than 10 μm, is preferably equal to or less than 9.0 μm, and is further preferably equal to or less than 8.0 μm.

When the volume median diameter of the toner is excessively large, the charging amount per unit weight may become small, and occurrence of fog and scattering of toner may be increased. In addition, when the volume median diameter of the toner is excessively small, the charging amount per unit weight is likely to be excessive, and thereby a problem such as extreme image density reduction is likely to occur in some cases. The volume median diameter is measured by a method described in Examples.

The average circularity of the toner base particles of the toner used in the present invention is typically equal to or greater than 0.945, and is preferably equal to or greater than 0.950. Further, typically, it is equal to or less than 0.990, and is preferably equal to or less than 0.985.

When the circularity is excessively large, slipping in a cleaning portion is likely to occur, and thus image defects are caused in some cases. On the other hand, when the circularity is excessively small, when the inorganic particle rolls on the surface of the base particle due to the mechanical stress inside the machine, it falls into the depression of the base particle, and thus the effect of the present invention cannot be maintained to the end in some cases.

The circularity of the toner base particle is measured by using the method described in Examples.

The constituent material of the toner used in the present invention is not particularly limited, and includes at least a binder resin and a coloring agent, and as necessary, contains a charge control agent, a wax, and other external additives.

The method of producing the toner base particles used in the present invention is not limited, a pulverization method, a wet method, a method of making the toner spherical by mechanical impact force, heat treatment, or the like can be used. Examples of the wet method include a suspension polymerization method, an emulsion polymerization and aggregation method, a dissolution suspension method, and an ester extension method.

In the pulverization method, a predetermined amount of a binder resin, a coloring agent, and as necessary, other components are weighed and mixed. Examples of the mixing device include a double combination mixer, a V mixer, a drum type mixer, a super mixer, a Henschel mixer, and a Nauta mixer.

Next, the toner raw material blended and mixed above is melted and kneaded so as to melt the resins, and the coloring agent and the like are dispersed therein. In the melting and kneading step, for example, a batch type kneading machine such as a pressure kneader, a Banbury mixer, or a continuous type kneading machine can be used. As a kneading machine, a single- or twin-screw extruder is used, for example, a KTK-type twin-screw extruder manufactured by Kobe Steel Ltd., a TEM-type twin-screw extruder manufactured by Toshiba Machine Co., Ltd, a twin-screw extruder manufactured by KCC Corporation, and a co-kneader manufactured by Buss Co., Ltd. Further, a colored resin composition obtained by melt-kneading the toner raw material is melted and kneaded, rolled with two rolls or the like, and cooled by water cooling in a cooling step.

The cooled product of the colored resin composition obtained as described above is then pulverized until a desired particle size is obtained in the pulverization step. In the pulverization step, first, the cooled product was crushed with a crusher, a hammer mill, a feather mill or the like, and further pulverized with a cryptron system manufactured by Kawasaki Heavy Industries, Ltd., and a super rotor manufactured by Nisshin Engineering Co., Ltd.

After that, as necessary, the toner base particles are obtained by classifying with a sieving machine of a classifier such as an inertial classification type elbow jet (manufactured by Nittetsu Mining Co., Ltd.) and a centrifugal classification type turboplex (manufactured by Hosokawa Micron Corporation). Further, the toner may be spheroidized using a conventionally used method. After obtaining the toner base particle, a toner can be obtained through a processing step of adding an external additive and other processing steps, as necessary.

Examples of the wet method include an emulsion polymerization and aggregation method, a suspension polymerization method, and a dissolution suspension method, and any method may be used for production without particular limit.

In a case of producing the toner base particles by using the emulsion polymerization and aggregation method, examples thereof include, typically, a polymerization step of polymerizing a polymer particle so as to obtain a polymer particle dispersion, a mixing step of mixing the polymer particle dispersion and a coloring agent particle dispersion, an aggregating step of adding an aggregating agent to the mixture and aggregating the mixture to be a desired particle size, thereby obtaining a particle aggregate (aggregated particle), a fusion step of heating and fusing the aggregated particles to form a fused particle, and them a step of obtaining as toner base particles such as a filtration step, a washing step, and a drying step.

In the present invention, in the method of producing suspension polymerization toner, a coloring agent, a polymerization initiator, and as necessary, external additives such as wax, a polar resin, a charge control agent, and a crosslinking agent are added into the monomer of the binder resin, and thereby a uniformly dissolved or dispersed monomer composition is produced. This monomer composition is dispersed in an aqueous medium containing a dispersion stabilizer or the like.

It is preferable that the stirring speed and time are adjusted such that a liquid droplet of the monomer composition has a desired toner particle size, and then granulation is performed carried out. Thereafter, by the action of the dispersion stabilizer, polymerization is performed by stirring to the extent that a particle state is maintained and particle sedimentation is prevented. These can be collected by washing and filtration, and then drying is performed so to obtain a toner base particle. After obtaining the toner base particle, a toner can be obtained through a processing step of adding an external additive and other processing steps, as necessary.

The dissolution suspension method is a method in which a solution phase obtained by dissolving a binder resin in an organic solvent and adding and dispersing a coloring agent or the like is dispersed by a mechanical shearing force in an aqueous phase containing a dispersant or the like to form a liquid droplet, and the organic solvent is removed from the liquid droplet, thereby producing a toner particle.

The ester extension method is a method in which an oil phase in which a wax, a polyester resin, a pigment, and the like are dispersed and an aqueous phase to which a particle size control agent and a surfactant are added are mixed and emulsified to produce an oil droplet, the oil droplets converge at the same time that a polymer resin component is formed on the surface of the toner oil droplet by elongation reaction, and then the solvent inside the oil droplet is removed, thereby producing a toner particle.

In the present invention, as the binder resin contained in the toner, the resins conventionally used as the binder resin of the toner can be appropriately used.

Examples of the binder resin used in a case of producing the toner base particles by using the pulverization method include polystyrene, a homopolymer of styrene substitution substance, a styrene copolymer, an acrylic acid, a methacrylic acid, a polyester resin, a polyamide resin, an epoxy resin, a xylene resin, and a silicone resin. The resins may be used alone, or may be used in combination.

As the binder resin used in a case of producing the toner base particles by using the polymerization method, a vinyl polymerizable monomer capable of radical polymerization can be exemplified. Examples thereof include a styrene, a styrene derivative, an acrylic polymerizable monomer, a methacrylic polymerizable monomer, vinyl ester, vinyl ether, and vinyl ketone. These resins may be used alone or two or more kinds thereof may be used in combination.

Examples of the monomer include any polymerizable monomer such as a polymerizable monomer having an acidic group (hereinafter, simply referred to as an acidic monomer in some cases), a polymerizable monomer having a basic group (hereinafter, simply referred to as a basic monomer in some cases), and a polymerizable monomer having neither an acidic group nor a basic group (hereinafter, referred to as other monomers in some cases).

Among the above-described polymerization methods, in a case of producing the toner base particles by using the emulsion polymerization and aggregation method, in the emulsion polymerization step, a polymerizable monomer is generally polymerized in an aqueous medium in the presence of an emulsifier. In this case, when the polymerizable monomers are supplied to the reaction system, each monomer may be added separately or a plurality of kinds of the monomers may be mixed and added at the same time. Further, the monomer may be added as it is, or can also be added as an emulsion which is mixed and adjusted in advance with water, an emulsifier or the like.

Examples of the acidic monomer include a polymerizable monomer having a carbolxyl group such as an acrylic acid, a methacrylic acid, a maleic acid, a fumaric acid, and a cinnamic acid, a polymerizable monomer having a sulfonic acid group such as sulfonated styrene, and a polymerizable monomer having a sulfonamide group such as vinylbenzene sulfonamide.

In addition, examples of the basic monomer include an aromatic vinyl compound having an amino group such as aminostyrene, a nitrogen-containing heterocycle-containing polymerizable monomer such as vinylpyridine and vinylpyrrolidone, and a (meth)acrylic acid ester having an amino group such as dimethyl aminoethyl acrylate and diethyl aminoethyl methacrylate.

The acidic monomers and the basic monomers may be used alone, or two or more kinds thereof may be used in combination. Also, it may exist as a salt with a counter ion. Among them, an acidic monomer is preferably used and an acrylic acid and/or a methacrylic acid are/is further preferably used.

A total amount of the acidic monomer and the basic monomer occupied in 100 parts by mass of the polymerizable monomer constituting the binder resin is typically equal to or greater than 0.05 parts by mass, is preferably equal to or greater than 0.5 parts by mass, and is particularly preferably equal to or greater than 1.0 parts by mass. In addition, it is typically equal to or less than 10 parts by mass, and is preferably equal to or less than 5 parts by mass.

Examples of other polymerizable monomers include styrenes such as styrene, methyl styrene, chlorostyrene, dichlorostyrene, p-tert-butyl styrene, p-n-butyl styrene and p-n-nonyl styrene, acrylate esters such as methyl acrylate, ethyl acrylate, propyl acrylate, n-butyl acrylate, isobutyl acrylate, hydroxyethyl acrylate and 2-ethyl hexyl acrylate, methacrylic acid esters such as methyl methacrylate, ethyl methacrylate, propyl methacrylate, n-butyl methacrylate, isobutyl methacrylate, hydroxyethyl methacrylate, and 2-ethylhexyl methacrylate, acrylamide, N-propyl acrylamide, N, N-dimethyl acrylamide, N,N-dipropyl acrylamide, and N,N-dibutyl acrylamide. The polymerizable monomers may be used alone, or a plurality thereof may be used in combination.

In addition, in a case where the binder resin is a crosslinked resin, a polyfunctional monomer having radical polymerizability is used together with the above polymerizable monomer, and examples thereof include divinylbenzene, hexanediol diacrylate, ethylene glycol dimethacrylate, diethylene glycol dimethacrylate, diethylene glycol diacrylate, triethylene glycol diacrylate, neopentyl glycol dimethacrylate, neopentyl glycol diacrylate, and diallyl phthalate.

It is also possible to use a polymerizable monomer having a reactive group in a pendant group, such as glycidyl methacrylate, methylol acrylamide, and acrolein. Among them, a radically polymerizable bifunctional polymerizable monomer is preferable, and divinylbenzene and hexanediol diacrylate are particularly preferable. These polyfunctional polymerizable monomers may be used alone or a plurality thereof may be used in combination.

In a case of polymerizing the binder resin by using the emulsion polymerization and aggregation method, a known surfactant can be used as an emulsifier. As the surfactant, one or more surfactants selected from among a cationic surfactant, an anionic surfactant, and a nonionic surfactant can be used in combination.

Examples of the cationic surfactant include dodecyl ammonium chloride, dodecyl ammonium bromide, dodecyl trimethyl ammonium bromide, dodecyl pyridinium chloride, dodecyl pyridinium bromide, and hexadecyl trimethyl ammonium bromide.

Examples of the anionic surfactant include fatty acid soap such as sodium stearate and sodium dodecanoate, sodium dodecyl sulfate, sodium dodecylbenzene sulfonate, and sodium lauryl sulfate.

Examples of the nonionic surfactant include polyoxyethylene dodecyl ether, polyoxyethylene hexadecyl ether, polyoxyethylene nonyl phenyl ether, polyoxyethylene lauryl ether, polyoxyethylene sorbitan monooleate ether, and monodecanoyl sucrose.

The use amount of the emulsifier in a case of producing the toner base particles by using the emulsion polymerization and aggregation method is not particularly limited, and is in a range of 0.1 parts by mass to 10 parts by mass with respect to 100 parts by mass of the polymerizable monomer.

In addition, with the above-described emulsifiers, one kind or two or more kinds of polyvinyl alcohols such as partial or fully saponified polyvinyl alcohol and cellulose derivatives such as hydroxyethyl cellulose can be used together as a protective colloid.

The volume average particle size of the primary polymer particle obtained by using the emulsion polymerization and aggregation method is typically equal to or greater than 0.02 μm, is preferably equal to or greater than 0.05 μm, and is particularly preferably equal to or greater than 0.1 μm. Further, it is typically equal to or less than 3 μm, is preferably equal to or less than 2 μm, and is particularly preferably equal to or less than 1 μm. When the particle size is excessively small, it is difficult to control the aggregating speed in the aggregating step in some cases. In addition, when the particle size is excessively large, the particle size of the toner particle obtained by aggregating is likely to be large, and thus it is difficult to obtain the toner having a desired particle size in some cases.

In a case of producing the toner base particles by using the emulsion polymerization and aggregation method, it is possible to use a well-known polymerization initiator as necessary, and the polymerization initiator can be used alone, or two or more kinds thereof can be used in combination.

Examples thereof include persulfate such as potassium persulfate, sodium persulfate, and ammonium persulfate; a redox initiator obtained by combining these persulfates as a component with a reducing agent such as acidic sodium sulfite; a water soluble polymerization initiator such as hydrogen peroxide, a 4,4′-azobiscyanovaleric acid, t-butyl hydroperoxide, and cumene hydroperoxide; a redox initiator obtained by combining these water-soluble polymerizable initiators as a component with a reducing agent such as ferrous salt; benzoyl peroxide; and 2,2′-azobis-isobutyronitrile. These polymerization initiators may be added to the polymerization system before, simultaneously with, or after the addition of the monomer, and these addition methods may be combined as necessary.

In the case of producing the toner base particles using the emulsion polymerization and aggregation method, a known chain transfer agent can be used as necessary. Specific examples include t-dodecyl mercaptan, 2-mercaptoethanol, diisopropyl xanthogen, carbon tetrachloride, and trichlorobromomethane. The chain transfer agent may be used alone or two or more kinds thereof may be used in combination, and the content thereof is in a range of 0% to 5% by mass with respect to the polymerizable monomer.

In addition, in a case of producing the toner base particles by using the emulsion polymerization and aggregation method, a known suspension stabilizer can be used as necessary. Specific examples of the suspension stabilizer include calcium phosphate, magnesium phosphate calcium hydroxide, and magnesium hydroxide. These may be used alone or two or more kinds thereof may be used in combination. The content of the suspension stabilizer can be used, typically, in a range of 1 parts by mass to 10 parts by mass with respect to the 100 parts by mass of the polymerizable monomer.

The polymerization initiator and the suspension stabilizer may be added to the polymerization system before, simultaneously with, or after the addition of the polymerizable monomer and these addition methods may be combined as necessary.

In addition, a pH regulator, a polymerization degree regulator, and an antifoaming agent can be appropriately added to the reaction system.

The toner used in the image forming method of the present invention may contain wax for imparting releasability. As the wax, any wax can be used as long as it has releasability.

Specific examples of the wax include olefin wax such as low molecular weight polyethylene, low molecular weight polypropylene, and copolymer polyethylene, paraffin wax, ester wax having a long chain aliphatic group such as behenyl behenate, montanic acid ester, stearyl stearate, plant wax such as hydrogenated castor oil and carnauba wax, a higher fatty acid such as ketone having a long chain alkyl group such as distearyl ketone, silicone having an alkyl group, and a stearic acid, long chain aliphatic alcohol such as eicosanol, polyhydric alcohol such as glycerin and pentaerythritol, carboxylic acid ester or partial ester of polyhydric alcohol obtained by long-chain fatty acid, higher fatty acid amide such as oleic acid amide and stearic acid amide, and low molecular weight polyester.

Among these waxes, in order to improve fixability, the melting point of the wax is, typically, equal to or higher than 30° C., is preferably equal to or higher than 40° C., and is particularly preferably equal to or higher than 50° C. In addition, the melting point of the wax is, typically, equal to or lower than 100° C., is preferably equal to or lower than 90° C., and is particularly preferably equal to or lower than 80° C. When the melting point is excessively low, the wax may be exposed on the surface after fixation and may be sticky in some cases. On the other hand, when the melting point is excessively high, the fixability at low temperature may be deteriorated in some cases.

Also, as the compound kind of the wax, a higher fatty acid ester wax is preferable. Specific examples of the higher fatty acid ester wax preferably include ester of fatty acid having 15 to 30 carbon atoms and monovalent to pentavalent alcohols such as stearic acid ester of behenyl behenate, stearyl stearate, pentaerythritol, and montanic acid glyceride. In addition, as the alcohol component constituting the ester, in the case of monohydric alcohol, the number of carbon atoms is preferably in a range of 10 to 30, and in the case of polyhydric alcohol, the number of carbon atoms is preferably in a range of 3 to 10.

The wax may be used alone or in combination. In addition, the melting point of the wax compound can be appropriately selected depending on the fixing temperature at which the toner is fixed.

In the present invention, in a case of containing the wax, the content of the wax is not particularly limited, but typically, it is equal to or greater than 1 parts by mass, is preferably equal to or greater than 2 parts by mass, and is particularly preferably equal to or greater than 5 parts by mass, with respect to 100 parts by mass of the toner. Further, but typically, it is equal to or less than 40 parts by mass, is preferably equal to or less than 35 parts by mass, and is particularly preferably equal to or less than 30 parts by mass, with respect to 100 parts by mass of the toner.

When the wax content in the toner is excessively small, performance such as high-temperature offset may not be sufficient in some cases. On the other hand, the wax content in the toner is excessively large, the blocking resistance may be insufficient, or the wax may leak from the toner and contaminate the apparatus in some cases.

As the coloring agent contained in the toner used in the present invention, any well-known coloring agent can be used. Specific examples of the coloring agent include well-known dyes or pigments such as a carbon black, aniline blue, phthalocyanine blue, phthalocyanine green, Hansa yellow, rhodamine type dye and pigment, chromium yellow, quinacridone, benzidine yellow, rose bengale, triallyl methane dye, a monoazo dye or pigment, a disazo dye or pigment, a condensed azo dye or pigment, which can be used alone or in combination.

In a case of the full-color toner, it is preferable to use benzidine yellow, monoazo dye, condensed azo dye for yellow, quinacridone and monoazo dye for magenta, and phthalocyanine blue for cyan, respectively. The coloring agent is preferably used in a range of 3 parts by mass to 20 parts by mass with respect to 100 parts by mass of primary polymer particles.

Typically, the mixing of the coloring agents in the emulsion polymerization and aggregation method is performed in an aggregating step. A mixed dispersion is obtained by mixing a dispersion of the primary polymer particles and a dispersion of the coloring agent particles, and the mixed dispersion is aggregated so as to obtain a particle aggregate. The coloring agent is preferably used in a state of being dispersed in water under the presence of an emulsifier. The volume average particle size of the coloring agent particle is typically equal to or greater than 0.01 μm, and is preferably equal to or greater than 0.05 μm. In addition, the volume average particle size of the coloring agent particle is typically equal to or less than 3 μm, and is preferably equal to or less than 1 μm.

In the present invention, a charge control agent may be used, as necessary. In a case of using the charge control agent, any well-known charge control agent can be used alone or in combination.

Examples of the positively chargeable charge control agent include azine black dyes such as quaternary ammonium salt, nigrosine, processed nigrosine, and alkylnigrosine, a processed nigrosine compound, a guanidine compound, a triphenyl sulfonium compound, a resin charge control agent, an amide group containing compound, a basic/electron donative metal substance.

Examples of the negatively chargeable charge control agent include metal chelates of an aromatic oxycarboxylic acid and an aromatic dicarboxylic acid, a monoazo metal complex compound, a metal salt of organic acid, metal-containing dye, a diphenyl hydroxy complex compound, an iron-containing azo compound, a home electronics control agent for emulsion polymerization emulsion polymerization, various oxycarboxylic acid metal complex compounds, a calixarene compound, a phenol compound, a resin charge control agent, a naphthol compounds and their metal salt, an urethane bond-containing compound, and an acidic or electron-withdrawing organic substance.

In addition, among the toners used in the present invention, as toners other than the black toner, it is preferable to use a charge control agent which is colorless or light color and has no color tone disturbance to the toner. For example, as a positively chargeable charge control agent, a quaternary ammonium salt compound is preferably used. As a negatively chargeable charge control agent, a metal salt or metal complex with zinc of a salicylic acid or an alkyl salicylic acid, and aluminum, or the like, a metal salt or metal complex with benzilic acid, and a hydroxynaphthalene compound such as an amide compound, a phenol compound, a naphthol compound, a phenolamide compound, and 4,4′-methylenebis[2-[N-(4-chlorophenyl)amido]-3-hydroxynaphthalene.

In the toner used in the present invention, in a case of containing the charge control agent in the toner by using the emulsion polymerization and aggregation method, it is possible to perform the mixing by a method of adding the charge control agent with the polymerizable monomer at the time of the emulsion polymerization, a method of adding the charge control agent with the primary polymer particle and the coloring agent in the aggregating step, or a method of adding the charge control agent after the primary polymer particle and the coloring agent are aggregated so as to obtain almost a target particle size. Among them, it is preferable that the charge control agent is added by being dispersed in water by using a surfactant such that a dispersion has a volume average particle size in a range of 0.01 μm to 3 μm in the aggregating step.

In the emulsion polymerization and aggregation method, the aggregation is typically performed in a tank provided with a stirring device, but examples of the method include a heating method, a method of adding an electrolyte, and a method of combining them. In a case of aggregating the primary polymer particles while being stirred so as to obtain a particle aggregate having a desired size, the particle size of the particle aggregate is controlled from the balance between the cohesive force between the particles and a shearing force by the stirring; however, it is possible to increase the cohesive force by heating or by adding the electrolyte.

In the present invention, as the electrolyte in the case where the aggregation is performed by adding electrolyte, an organic salt or an inorganic salt may be used, and specific examples thereof include NaCl, KCl, LiCl, Na₂SO₄, K₂SO₄, Li₂SO₄, MgCl₂, CaCl₂, MgSO₄, CaSO₄, ZnSO₄, Al₂(SO₄)₃, Fe₂(SO₄)₃, CH₃COONa, and C₆H₅SO₃Na. Among them, an inorganic salt having a polyvalent metal cation having dicalent or higher polyvalent is preferable.

In the toner used in the present invention, the amount of the electrolyte added varies depending on kinds of electrolytes, a target particle size, or the like, and it is typically equal to or greater than 0.05 parts by mass, and is preferably equal to or greater than 0.1 parts by mass with respect to 100 parts by mass of solid component of mixed dispersion. In addition, it is typically equal to or less than 25 parts by mass, is preferably equal to or less than 15 parts by mass, and is particularly preferably equal to or less than 10 parts by mass, with respect to 100 parts by mass of solid component of mixed dispersion.

When the amount of electrolyte added is excessively small, a progress of the aggregation reaction is delayed and fine powder of equal to or less than 1 μm remains even after the aggregation reaction, and thus a problem in that the average particle size of the obtained particle aggregate do not reach the target particle size occurs in some cases. On the other hand, when the amount of electrolyte added is excessively large, the particles are likely to be rapidly aggregated and the particle size is difficult to control, and thus a problem in that coarse powders and irregular particles may be contained in the obtained aggregated particles occurs in some cases.

The aggregation temperature in a case where the aggregation is performed by adding the electrolyte is typically equal to or higher than 20° C., and is preferably equal to or higher than 30° C. Further, the aggregation temperature is typically equal to or lower than 70° C., and is preferably equal to or lower than 60° C.

When the glass transition temperature of the primary polymer particle is set as Tg, the aggregation temperature in a case where the aggregation is performed only by heat without using the electrolyte is typically equal to or higher than (Tg-20°) C., and is preferably equal to or higher than (Tg-10°) C. In addition, the aggregation temperature is typically equal to or lower than Tg, and is equal to or lower than (Tg-5°) C.

The time required for aggregation is optimized depending on the apparatus shape and processing scale; however, in order to make the particle size of the toner reach a target particle size, it is generally preferable to hold the above-mentioned predetermined temperature for at least 30 minutes or longer. The temperature raised up to a predetermined temperature may be raised at a constant rate or may be raised at in a stepwise manner.

It is also possible to form particles having the resin particles adhered or fixed to the surface of the particle aggregate after aggregation treatment, as necessary. When the resin particles with controlled properties are adhered or fixed to the surface of the particle aggregate, it is possible to improve the chargeability and heat resistance of the obtained toner in some cases, and also the effect of the present invention can be more remarkable.

In a case where a resin particle having a glass transition temperature higher than the glass transition temperature of the primary polymer particles is used as a resin particle, further improvement of blocking resistance can be realized without impairing fixability, which is preferable. The volume average particle size of the resin particle is typically equal to or greater than 0.02 μm, and is preferably equal to or greater than 0.05 μm. In addition, the volume average particle size of the resin particle is typically preferably equal to or less than 3 μm, and is preferably equal to or less than 1.5 μm. As the resin particles, those obtained by emulsion polymerization of the same monomer as the polymerizable monomer used for the above-described primary polymer particles can be used.

The resin particles are usually used as a dispersion dispersed in water or a liquid mainly containing water by a surfactant, but in a case where the charge control agent is added after the aggregating treatment, the resin particle is preferably added after the charge control agent is added to the dispersion containing the particle aggregate.

In order to enhance the stability of the particle aggregate obtained in the aggregating step, it is preferable to perform fusion within the aggregated particles in an aging step after the aggregating step. The temperature of the aging step is typically equal to or higher than Tg of the primary polymer particles, and is preferably equal to or higher than the temperature which is equal to or higher than Tg by 5° C. In addition, it is typically the temperature which is equal to or lower than Tg by 80° C., and is preferably the temperature which is equal to or lower than Tg by 50° C.

In addition, the time required for the aging step varies depending on the shape of the target toner, but after the primary polymer particle reaches the glass transition temperature or higher, it is typically held in a range of 0.1 to 10 hours, and is preferably in a range of 1 to 6 hours.

Note that, it is preferable that the surfactant is added or a pH value is increased in the stage after the aggregating step, or preferably before the aging step or in the middle of the aging step. As the surfactant used here, one or more kinds of emulsifiers that can be used for producing the primary polymer particle can be selected, and the same emulsifier as used in the producing of the primary polymer particle can be particularly used.

In a case of adding the surfactant, the amount added is not limited, and it is typically equal to or greater than 0.1 parts by mass, is preferably equal to or greater than 1 part by mass, and is particularly preferably equal to or greater than 3 parts by mass, with respect to 100 parts by mass of solid component of mixed dispersion. In addition, it is typically equal to or less than 20 parts by mass, is preferably equal to or less than 15 parts by mass, and particularly preferably equal to or less than 10 parts by mass, with respect to 100 parts by mass of solid component of mixed dispersion.

When the surfactant is added or the pH value is increased between before the aging step after the aggregating step or before the completion of the aging step, it is possible to suppress the aggregation of the aggregated particle aggregates in the aggregating step and to suppress the forming of the coarse particles after the aging step in some cases.

By heat treatment in the aging step, the primary polymer particles in the aggregate are fused and integrated, and the toner particle shape as the aggregate is also made close to a spherical shape. Although the particle aggregate before the aging step is thought to be an aggregate due to electrostatic or physical aggregation of primary polymer particles, after the aging step, the primary polymer particles constituting the particle aggregate are fused to each other, and the shape of the toner particle can also be made close to a spherical shape.

According to such an aging step, by controlling the temperature and time of the aging step, toner having various shapes can be produced according to the purpose, such as a grape type in which the primary polymer particles are aggregated, a potato type in which fusion has advanced, and a spherical shape in which fusion has advanced.

The obtained particles are subjected to solid-liquid separation by a known method, collected, washed, and dried as necessary, and thereby the toner base particles can be obtained.

It is possible to obtain toner by externally adding an external additive to the toner base particle in accordance with the definition of the present invention by the external addition step described above.

### <2. Image Forming Method of the Present Invention>

The image forming method of the present invention includes the following steps.

(1) A developing step of carrying a toner image on the electrophotographic photoreceptor with an electrostatic latent image by using an electrophotographic cartridge equipped with an electrophotographic photoreceptor and toner for developing an electrostatic latent image
(2) A transfer step of transferring the toner image on the electrophotographic photoreceptor to a freely movable transfer material transporting body
(3) A fixing step of fixing the toner image transferred on the transfer material transporting body to a recording medium
(4) A cleaning step of removing the toner remaining in the transfer step from the surface of the transfer material transporting body by a cleaning member for a transfer material transporting body

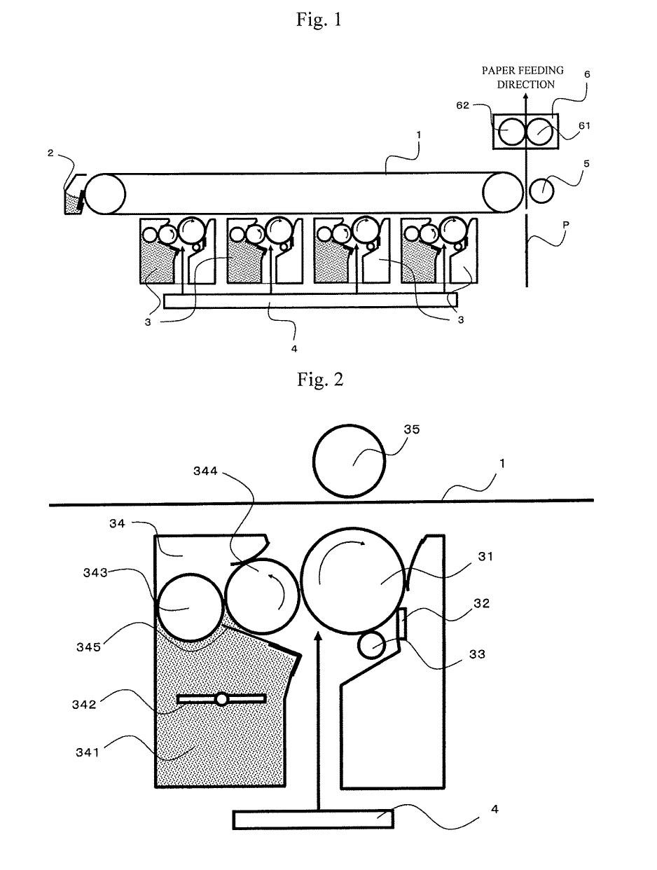

The above-described steps can be performed by an image forming apparatus which includes a transfer material transporting body, and uses an electrophotographic cartridge. Regarding embodiments of the image forming apparatus which includes the transfer material transporting body, and uses the electrophotographic cartridge, a main configuration of the apparatus will be described below with reference to FIGS. 1 and 2, and the developing step, transfer step, the fixing step, and the cleaning step will be described. Here, the embodiments are not limited to the following description, and can be implemented by arbitrary modification without departing from the gist of the present invention.

### <2-1. Image Forming Apparatus>

The main configuration of the image forming apparatus will be described with reference to FIG. 1.

As illustrated in FIG. 1, the image forming apparatus used in the image forming method of the present invention includes a transfer material transporting body 1, and a cleaning blade 2 for transfer material transporting body, which is cleaning member and is provided along the transfer material transporting body 1, and performs the cleaning of removing the toner remains on the surface of the transfer material transporting body 1 in the transfer step.

Here, in a case where the longitudinal length of the cleaning blade 2 for the transfer material transporting body installed in the transfer material transporting body 1 is equal to or greater than 32 cm as represented by a A3 machine and other large printing machines, the contact pressure between the blade and the transfer material transporting body at an end portion becomes weaker than at a central portion, the cleaning problem is likely to occur at the end portion of the transfer material transporting body.

When the present invention is applied to the case where the longitudinal length of the cleaning blade 2 for the transfer material transporting body installed in the transfer material transporting body 1 is equal to or greater than 32 cm, the effect of the present invention is more remarkably exhibited. The longitudinal length of the cleaning blade 2 for the transfer material transporting body is preferably equal to or greater than 35 cm. Note that, the longitudinal length of the cleaning blade 2 for the transfer material transporting body is typically equal to or less than 95 cm.

Further, the image forming apparatus is configured to include an electrophotographic cartridge 3, an exposure device 4, a transfer device 5, and a fixing device 6.

Since the electrophotographic cartridge 3 develops toner T in the transfer material transporting body 1, FIG. 1 illustrates a toner cartridge having an electrophotographic photoreceptor 31 as an example.

The electrophotographic cartridge 3 is provided with the electrophotographic photoreceptor 31 and the toner for developing an electrostatic charge image. With the electrophotographic cartridge 3, toner image is carried on the electrophotographic photoreceptor 31 by an electrostatic latent image.

The kind of the exposure device 4 is not particularly limited as long as it can expose the electrophotographic photoreceptor of the electrophotographic cartridge 3 to form an electrostatic latent image on the photosensitive surface of the electrophotographic photoreceptor 31. Specific examples include an LED Halogen lamp, a fluorescent lamp, a laser such as a semiconductor laser and He—Ne laser. In addition, the exposure may be performed by a photoreceptor internal exposure method.

Light for exposure is arbitrary, but for example, exposure may be performed by monochromatic light with a wavelength of 780 nm, monochromatic light having a slightly short wavelength in a range of 600 nm to 700 nm, and monochromatic light having a short wavelength in a range of 380 nm to 500 nm. Among them, when the short wavelength in a range of 380 to 500 nm is used, the resolution is increased, which is preferable. Among them, the monochromatic light having the wavelength of 405 nm is preferable.

The kind of the transfer device 5 is not particularly limited, and an apparatus using any method such as an electrostatic transfer method such as corona transfer, roller transfer, or belt transfer, a pressure transfer method, an adhesive transfer method can be used. Here, the transfer device 5 is disposed to face the transfer material transporting body 1. The transfer device 5 applies a predetermined voltage value (transfer voltage) having a polarity opposite to the charged potential of the toner T, and transfers the toner image transferred to and formed on the transfer material transporting body 1 to a recording medium (paper, medium) P.

When the toner transferred on the recording medium P passes between an upper fixing member 61 heated to a predetermined temperature and a lower fixing member 62, the toner is heated to be melted, cooled after passing, and then fixed on the recording sheet P.

Note that, the kind of the fixing device is not particularly limited, and in addition to the devices used here, it is possible to provide a fixing device by any method such as a heat roller fixing method, a flash fixing method, an oven fixing method, and a pressure fixing method.

### <2-2. Electrophotographic Cartridge>

In addition, a main configuration of an electrophotographic cartridge used for an image forming apparatus will be described with reference to FIG. 2.

As illustrated in FIG. 2, the electrophotographic cartridge is configured to include an electrophotographic photoreceptor 31, a cleaning blade 32 for photoreceptor, a charging device 33, an exposure device 4, and a developing device 34, and as necessary, a transfer device 35 is provided therein.

The electrophotographic photoreceptor 31 is not particularly limited as long as it is an electrophotographic photoreceptor, and FIG. 2 illustrates, as an example, a drum photoreceptor in which the above-described photosensitive layer is formed on the surface of a cylindrical conductive support. Along an outer periphery of the electrophotographic photoreceptor 31, the cleaning blade 32 for photoreceptor, the charging device 33, the exposure device 4, the developing device 34, and the transfer device 35 are disposed.

The charging device 33 charges the electrophotographic photoreceptor 31 and uniformly charges the surface of the electrophotographic photoreceptor 31 to a predetermined potential. As a charging device, a corona charging device such as corotron or scorotron, a contact charging device such as a charging brush of a direct charging device (contact charging device) which brings a voltage-applied direct charging member into contact with the photoreceptor surface and charges it. Examples of direct charging means include a charging roller, a contact charger such as a charging brush.

Note that, FIG. 2 illustrates a roller type charging device (charging roller) as an example of the charging device 33. As direct charging means, charging with aerial discharge or injection charging without accompanying aerial discharge is possible. As a voltage to be applied at the time of charging, it is possible to use only a DC voltage, or to superimpose an AC on a DC current.

The kind of developing device 34 is not particularly limited, and it is possible to use any device such as a dry developing method such as cascade development, one component insulating toner development, one component conductive toner development, and two component magnetic brush development, or a wet developing method. In FIG. 2, the developing device 34 is configured to include a developing vessel 341, an agitator 342, a feed roller 343, a developing roller 344, and a control member 345, and has a configuration in which the toner T is stored in the inside of the developing vessel 341.

Further, as necessary, a developing device 34 may be provided with a replenishing device (not shown) for replenishing the toner T. This replenishing device is configured to be able to replenish the toner T from a container such as a bottle, and a cartridge.

The feed roller 343 is formed of a conductive sponge or the like. The developing roller 344 is made of a metal roll such as iron, stainless steel, aluminum, and nickel, or a resin roll in which such a metal roll is coated with a silicone resin, a urethane resin, and a fluororesin. The surface of the developing roller 344 may be subjected to smoothing or rough surface processing as necessary.

The developing roller 344 is disposed between the electrophotographic photoreceptor 31 and the feed roller 343, and is brought into contact with each of the electrophotographic photoreceptor 31 and the feed roller 343. The feed roller 343 and the developing roller 344 are rotated by a rotary drive mechanism (not shown). The feed roller 343 carries and supplies the stored toner T to the developing roller 344. The developing roller 344 carries the toner T supplied by the feed roller 343 such that the toner T comes in contact with the electrophotographic photoreceptor 31.

The control member 345 is formed of a resin blade such as a silicone resin or a urethane resin, a metal blade such as stainless steel, aluminum, copper, brass, and phosphor bronze, or a blade in which such a metal blade is coated with a resin. The control member 345 is brought into contact with the developing roller 344, and is pressurized (general blade linear pressure is in a range of 5 to 500 g/cm) by a predetermined force to the developing roller 344 side with a spring or the like. As necessary, the control member 345 may have a function of applying charges on the toner T by a frictional charge with the toner T.

The agitator 342 is rotated by a rotation driving mechanism, and stirs the toner T and transports the toner T to the feed roller 343 side. A plurality of agitators 342 with different blade shapes, sizes, and the like may be provided.

The cleaning blade 32 for photoreceptor is not particularly limited, and any cleaning apparatus such as a brush cleaner, a magnetic brush cleaner, an electrostatic brush cleaner, a magnetic roller cleaner, and a blade cleaner can be used. The cleaning blade 32 for photoreceptor scrapes residual toner adhering to the electrophotographic photoreceptor 31 with a cleaning member and collects the residual toner. Here, in a case where there is little or scarcely toner remaining on the surface of the photoreceptor, the cleaning blade 32 for photoreceptor is not required.

The kind of the transfer device 35 is not particularly limited, and an apparatus using any method such as an electrostatic transfer method such as corona transfer, roller transfer, or belt transfer, a pressure transfer method, an adhesive transfer method can be used. Here, the transfer device 35 is disposed to face the electrophotographic photoreceptor 31. The transfer device 35 applies a predetermined voltage value (transfer voltage) having a polarity opposite to the charged potential of the toner T, and transfers the toner image formed on the electrophotographic photoreceptor 31 to a freely movable transfer material transporting body.

### EXAMPLES

Hereinafter, the present invention will be described more specifically with reference to examples, but the present invention is not limited to the following examples as long as the gist is not exceeded. In the following examples, “part” means “parts by mass”, “%” means “% by mass”.

### <Method of Measuring Average Particle Size of Primary Polymer Particles>

By using a model: Microtrac Nanotrac 150 (hereinafter, abbreviated as “Nanotrac”) manufactured by Nikkiso Co., Ltd., in accordance with the instruction manual of Nanotrac, analysis software of Microtrac Particle Analyzer Ver 10.1.2.-019EE manufactured by the same company and ion exchanged water having conductivity of 0.5 μS/cm as the dispersion medium were used so as to measure the average particle size of the primary polymer particles under the following conditions or by a method in which the following conditions were described.
Solvent refractive index: 1.333
Measurement time: 100 seconds
Number of measurements: once
Particle refractive index: 1.59
Transparency: transparent
Shape: Spherical shape
Density: 1.04

### <Method of Measuring Volume Median Diameter (Dv50) of Toner Particle>

By using Multisizer III (aperture diameter of 100 μm) manufactured by Beckman Coulter, Inc. (hereinafter, abbreviated as “Multisizer”), the measurement was performed with Isoton II manufactured by the same company was used as the dispersion medium, and was dispersed so as to have a dispersoid concentration of 0.03% by mass. The measured particle size is in a range of 2.00 to 64.00 μm, and the range is discretized into 256 divisions so as to be equally spaced on a logarithmic scale, and those calculated on the basis of the statistical values on the volume basis are referred to as volume median diameter (Dv50).

### <Method of Measuring Circularity>

Regarding the “average circularity” in the present invention, the toner base particles were dispersed in a dispersion medium (Isoton II, manufactured by Beckman Coulter, Inc.) so as to be in the range of 5720 to 7140/μL, and then the measurement is performed by using a flow type particle image analyzer (manufactured by Sysmex Corporation (former Toa Medical Electronics Co., Ltd.), FPIA 3000) under the following apparatus conditions, and thereby the obtained value from the measurement is defined as “average circularity”. In the present invention, the same measurement is performed three times, and an arithmetic average value of three “average circularity” is adopted as “average circularity”.
Mode: HPF
HPF Analytical amount: 0.35 μL
Number of detected HPF: 2000 to 2500

The following circularity is indicated by being measured by the above apparatus and automatically calculated in the apparatus, and “the circularity” is defined by the following expression.

[circularity]=[circumference length having the same area as particle projected are]/[circumference length of particle projected image]

In addition, the number of detected HPF in a range of 2000 to 2500 is measured, and the arithmetic mean (arithmetic average) of the circularity of this individual particle is displayed on the apparatus as “average circularity”.

### [Method of Measuring Glass Transition Temperature (Tg) of Core Resin and Shell Resin of Base Particle]

The measurement was performed by using DSC7 manufactured by Perkin-Elmer Corporation. 10 mg of sample was put into an aluminum pan, a temperature was raised from 30° C. to 100° C. for 7 minutes, then rapidly lowered from 100° C. to −20° C., and raised from −20° C. to 100° C. for 12 minutes. A value of Tg observed at the time of second temperature rise was used. In a case where there are a plurality of endothermic peaks, the lowest endothermic peak temperature is defined as Tg. Note that, the core resin and the shell resin are measured by drying the moisture of the dispersion, and are measured by preparing a polymer without wax particles in a case where the endothermic peak of the wax particle interferes.

### <Method of Measuring Average Primary Particle Size of the External Additive>

The average primary particle size of the external additive can be measured using a transmission electron microscope image. For example, on the transmission electron microscope image, a method of obtaining the average primary particle size from the number average of the particle size by randomly selecting several thousand particles from the target external additives, or a method of obtaining an equivalent spherical diameter from a BET specific surface area measurement value can be exemplified.

### <Method of Measuring External Additives and BET Specific Surface Area of Toner>

The measurement is performed by one point method with liquid nitrogen by using Macsorb model-1208 manufactured by Mountech Co., Ltd. Specific described is as follows.

A cell made of glass is filled with 1.0 g of a target sample (hereinafter, this sample filling amount is referred to as A(g)). Next, the cell is set in a measuring instrument main body, and is dried and degassed at 200° C. for 20 minutes under a nitrogen atmosphere, and then is cooled to room temperature. Thereafter, the measurement gas (mixed gas of 30% primary nitrogen and 70% helium) is allowed to follow at a flow rate of 25 mL/min into the cell while cooling the cell with liquid nitrogen, and an adsorption amount V (cm³) of the measurement gas to the sample is measured. When the total surface area of the sample is set as S (m²), the BET specific surface area (m²/g) to be obtained can be calculated by the following calculation formula.

(BET specific surface area)=S/A=[K·(1−P/P0)·V]/A

K: gas constant (4.29 in the present measurement)
P/P0: relative pressure of adsorbed gas, 97% of mixing ratio (0.29 in the present measurement)

### <Method of Measuring Charging Amount>

The charging amount of the inorganic particle in the present invention is measured under the following conditions.

In the environment of temperature of 23° C. and humidity of 55%, 19.8 g of carrier: non-coated ferrite carrier (particle size of 80 produced by Powdertech Co., Ltd.) and 0.2 g of inorganic particle are put into a 20 ml of glass bottle, and is left to stand for 12 hours or more. After that, the glass bottle is shaken back and forth 50 times with hand and stirred for one minute with amplitude of 1.0 cm and shaking speed of 500 rpm.
0.2 g of the mixture is extracted from the glass bottle, and is measured under the following setting by using blow-off TB-200 apparatus manufactured by Toshiba Chemical.
N₂ pressure gauge: 1.0 Kg/cm²

### SET TIME: 20.0 sec

Wire mesh to be set on Faraday gauge (made of stainless steel: 400 mesh)
It is possible to obtain the charging amount Q/M (μC/g) per unit mass can be obtained by calculating the read value Q (μC) by the following calculation formula.

Q/M(μC/g)=−(Q(μC)/(measurement mass(g))

### <Method of Measuring Absolute Specific Gravity>

Using a Le Chatelier's specific gravity bottle, the absolute specific gravity was measured in accordance with JIS-K-0061 5-2-1. The operation was carried out as follows.

(1)) Into a Le Chatelier's specific gravity bottle, about 250 ml of ethyl alcohol is put and adjusted so that the meniscus is located at the scale mark position.
(2) The specific gravity bottle is immersed in a constant temperature water tank, and when the liquid temperature becomes 20.0±0.2° C., the position of the meniscus is accurately read out by the scale marks of the specific gravity bottle. (Precision: 0.025 ml).
(3) About 100 g of a sample is weighed, and its mass is designated as W.
(4) The weighed sample is put into the specific gravity bottle, and bubbles are removed.
(5) The specific gravity bottle is immersed in a constant temperature water tank, and when the liquid temperature becomes 20.0±0.2° C., the position of the meniscus is accurately read out by scale marks of the specific gravity bottle. (Precision: 0.025 ml).
(6) The absolute specific gravity is calculated by the following formulae.

D=W/(L2−L1)

S=D/0.9982

In the formulae, D is the density (20° C.) (g/cm³) of the sample, S is the absolute specific gravity (20° C.) of the sample, W is the apparent mass (g) of the sample, L1 is the read out value (20° C.) (ml) of the meniscus before the sample is put into the specific gravity bottle, L2 is the read out value (20° C.) (ml) of the meniscus after the sample is put into the specific gravity bottle, and 0.9982 is the density (g/cm³) of water at 20° C.

[Production Example of Electrostatic Charge Image Developing Toner]

### <Production of Wax Emulsion A>

20 parts by mass of paraffin wax (HNP9: produced by Nippon Seiro Co., Ltd, melting point of 77° C.) and 1.44 parts by mass of aqueous solution of 20% by mass of anionic surfactant (NEOGEN S-20D: sodium dodecylbenzene sulfonate aqueous solution produced by Dai-Ichi Kogyo Seiyaku Co., Ltd., hereinafter, abbreviated as “20% DBS aqueous solution”) were added to 50 parts by mass of ion exchanged water, and then emulsified under high pressure shear, thereby preparing paraffin wax emulsion (hereinafter, abbreviated as “wax emulsion A1”). Note that, the number average particle size (mn) measured by MICRO TRACK MT3300 manufactured by Nikkiso Co., Ltd. was 0.25 μm.

The melting point of the wax was measured at a heating rate of 10° C./min, and was set as the temperature at the peak of the peak showing the maximum endotherm in the DSC curve.

### <Production of Polymer Primary Particle Emulsion B1>

35.6 parts by mass of wax emulsion A1 and 283 parts by mass of ion exchanged water were put into a reaction container provided with a stirring device (three blades), a heating and cooling device, and a raw material•auxiliary agent charging device, and a temperature of the container was heated up to 90° C. under nitrogen flow while stirring the mixture. A mixture of [Polymerizable monomers and the like] and [Emulsifier aqueous solution] of <Formulation Table-1> was added for five hours while being stirred at a peripheral speed 2.78 m/s of tip of the stirring blade. The time at which the dropwise addition of the mixture was started was defined as “start polymerization”, and in 30 minutes after “start polymerization”, [Initiator aqueous solution-1] was added for 4.5 hours in parallel with the above operation. After adding of the mixture and [Initiator aqueous solution-1], [Initiator aqueous solution-2] was added for two hours. Even after adding of [Initiator aqueous solution-2], the stirring was continued so as to hold the internal temperature of 90° C. for one hour.

<Formulation Table-1>
[Polymerizable monomers and the like]

| | | |
|---|---|---|
| Styrene | 76.75 | parts by mass |
| Butyl acrylate | 23.25 | parts by mass |
| Acrylic acid | 1.5 | parts by mass |
| Hexanediol diacrylate | 0.7 | parts by mass |
| Trichlorobromomethane | 1.0 | parts by mass |

[Emulsifier aqueous solution]

| | | |
|---|---|---|
| 20% DBS aqueous solution | 1.0 | parts by mass |
| Ion exchanged water | 67.1 | parts by mass |

[Initiator aqueous solution-1]

| | | |
|---|---|---|
| 8% by mass of aqueous hydrogen peroxide | 15.52 | parts by mass |
| solution | | |
| 8% by mass of L (+)-ascorbic acid aqueous | 15.52 | parts by mass |
| solution | | |

[Initiator aqueous solution-2]

| | | |
|---|---|---|
| 8% by mass L (+)-ascorbic acid aqueous | 14.21 | parts by mass |
| solution | | |

Cooling was performed after the polymerization reaction, and thereby a milky polymer primary particle emulsion B1 was obtained. The volume average particle size (my) measured by using MICRO TRACK UPA was 0.24 μm, and the solid concentration was 20.4% by mass.

### <Production of Polymer Primary Particle Emulsion B2>

1.78 parts by mass of 20% DBS aqueous solution and 290 parts of ion exchanged water were put into a reaction container provided with a stirring device (three blades), a heating and cooling device, and a raw material•auxiliary agent charging device, and a temperature of the container was heated up to 90° C. under nitrogen flow. [Initiator aqueous solution-3] of <Formulation Table-2> was added at once while being stirred at a peripheral speed 2.78 m/s of tip of the stirring blade

Subsequently, with continued stirring, a mixture of [Polymerizable monomers and the like] and [Emulsifier solutions] in Formulation Table-2 was added for five hours. In addition, the time at which the dropwise addition of the mixture was started was defined as “start polymerization”, and [Initiator aqueous solution-4] was added for six hours from the start polymerization in parallel with the above operation. Even after adding of [Initiator aqueous solution-4], the stirring was continued so as to hold the internal temperature of 90° C. for one hour.

<Formulation Table-2>
[Polymerizable monomers and the like]

| | | |
|---|---|---|
| Styrene | 100.0 | parts by mass |
| Acrylic acid | 0.5 | parts by mass |
| Trichlorobromomethane | 0.5 | parts by mass |

[Emulsifier aqueous solution]

| | | |
|---|---|---|
| 20% DBS aqueous solution | 1.0 | parts by mass |
| Ion exchanged water | 66.0 | parts by mass |

[Initiator aqueous solution-3]

| | | |
|---|---|---|
| 8% by mass of aqueous hydrogen peroxide | 3.2 | parts by mass |
| solution | | |
| 8% by mass of L (+)-ascorbic acid aqueous | 3.2 | parts by mass |
| solution | | |

[Initiator aqueous solution-4]

| | | |
|---|---|---|
| 8% by mass of aqueous hydrogen peroxide | 18.9 | parts by mass |
| solution | | |
| 8% by mass of L (+)-ascorbic acid aqueous | 18.9 | parts by mass |
| solution | | |

Cooling was performed after the polymerization reaction, and thereby a milky polymer primary particle emulsion B2 was obtained. The volume average particle size (my) measured by using MICRO TRACK UPA was 0.15 μm, and the solid concentration was 19.5% by mass.

### <Production of Cy Toner Particle Dispersion>

A Cy toner particle dispersion having a core shell type structure was obtained by performing the following aggregating step (core material aggregating step•shell coating step)•circularization step with components in <Formulation Table-3>.

<Formulation Table-3>

| | | |
|---|---|---|
| Polymer primary particle emulsion B1 | 92.5 | parts by mass |
| As a solid content | | |
| Polymer primary particle emulsion B2 | 7.5 | parts by mass |
| As a solid content | | |
| Coloring agent (Pigment Blue 15:3) dispersion | 4.4 | parts by mass |
| Coloring agent as a solid content | | |
| 20% DBS aqueous solution | | |
| In a core material aggregating step, as a solid | 0.07 | parts by mass |
| content | | |
| In a circularization step, as a solid content | 3.0 | parts by mass |
| 0.5% by mass of aluminum sulfate aqueous | 0.05 | parts by mass |
| solution | | |
| As a solid content | | |

Core Material Aggregating Step

The polymer primary particle emulsion B1 and 20% DBS aqueous solution were put into a mixing container provided with a stirring device (double helical blade), a heating and cooling device, and a raw material•auxiliary agent charging device, and the mixture was stirred at a peripheral speed 0.8 m/s of tip of the stirring blade at the internal temperature of 10° C. for five minutes. Subsequently, peripheral speed of the tip of the stirring blade was increased up to 5.1 m/s, and the coloring agent dispersion was continuously added for 15 minutes and then held for five minutes.

After that, the internal temperature was raised up to 55° C. at 0.6° C./min while holding the peripheral speed. Then, the internal temperature was held at 55° C. until volume median diameter (Dv50) exceeded 6.95 μm by the measurement using Multisizer III.

Shell Coating Step

Thereafter, the polymer primary particle emulsion B2 was continuously added for 10 minutes and then held for 40 minutes.

Circularization Step

Subsequently, 20% DBS aqueous solution and 3.5 parts by mass of ion exchanged water for the circularization step are added for 25 minutes in total, then the temperature was raised up to 100° C., and was held at 99.5° C. until the average circularity exceeded 0.968 by the measurement using the flow type particle image analyzer FPIA-3000 (manufactured by Sysmex Corporation). After that, the temperature was cooled down to 30° C. at 2° C./min, and thereby a toner particle dispersion was obtained. At this time, the particle size Dv50 of the toner particle was 7.05 μm, and the average circularity measured by using FPIA-3000 was 0.970.

### <Production of Ma Toner Particle Dispersion>

A Ma toner particle dispersion having a core shell type structure was obtained by using the same method as that used in Example 1 except that components in <Formulation Table-4> were used and the holding temperature in the circularization step was set to be 100° C.

<Formulation Table-4>

| | | |
|---|---|---|
| Polymer primary particle emulsion B1 | 92.5 | parts by mass |
| As a solid content | | |
| Polymer primary particle emulsion B2 | 7.5 | parts by mass |
| As a solid content | | |
| Coloring agent (Pigment Red 269) dispersion | 5.0 | parts by mass |
| Coloring agent as a solid content | | |
| 20% DBS aqueous solution | | |
| In a core material aggregating step, as a solid | 0.0 | parts by mass |
| content | | |
| In a circularization step, as a solid content | 4.0 | parts by mass |
| 0.5% by mass of aluminum sulfate aqueous | 0.1 | parts by mass |
| solution | | |
| As a solid content | | |

### <Production of Ye Toner Particle Dispersion>

A Ye toner particle dispersion having a core shell type structure by using the same method as that used in Example 1 except that components in <Formulation Table-5> were used and the holding temperature was set to be 100° C.

<Formulation Table-5>

| | | |
|---|---|---|
| Polymer primary particle emulsion B1 | 92.5 | parts by mass |
| As a solid content | | |
| Polymer primary particle emulsion B2 | 7.5 | parts by mass |
| As a solid content | | |
| Coloring agent (Pigment Yellow 74) dispersion | 6.7 | parts by mass |
| Coloring agent as a solid content | | |
| 20% DBS aqueous solution | | |
| In a core material aggregating step, as a solid | 0.07 | parts by mass |
| content | | |
| In a circularization step, as a solid content | 3.0 | parts by mass |
| 0.5% by mass of aluminum sulfate aqueous | 0.1 | parts by mass |
| solution | | |
| As a solid content | | |

### <Production of Bk Toner Particle Dispersion>

A Bk toner particle dispersion having a core shell type structure was obtained by using the same method as that used in Example 1 except that components in <Formulation Table-6> were used and the holding temperature in the circularization step was set to be 96.5° C.

<Formulation Table-6>

| | | |
|---|---|---|
| Polymer primary particle emulsion B1 | 92.5 | parts by mass |
| As a solid content | | |
| Polymer primary particle emulsion B2 | 7.5 | parts by mass |
| As a solid content | | |
| Coloring agent (Carbon Black MA100S produced | 5.0 | parts by mass |
| by Mitsubishi Chemical Corporation) dispersion | | |
| Coloring agent as a solid content | | |
| 20% DBS aqueous solution | | |
| In a core material aggregating step, as a solid | 0.12 | parts by mass |
| content | | |
| In a circularization step, as a solid content | 3.0 | parts by mass |
| 0.5% by mass of aluminum sulfate aqueous | 0.1 | parts by mass |
| solution | | |
| As a solid content | | |

### <Cleaning and Drying Toner Particles>

After each of the above-described Cy toner particle dispersion, Ma toner particle dispersion, Ye toner particle dispersion, and Bk toner particle dispersion was produced, the toner particle dispersions were filtrated and cleaned with the ion exchanged water 63 times the toner particles passed by using a centrifuge (Peeler Centrifuge HZ: manufactured by Mitsubishi Kakoki kaisha, Ltd). In addition, the cleaned toner particles were dried until the moisture amount under the atmosphere of 40° C. became 0.2% by mass, and thereby a Cy toner base particle, a Ma toner base particle, a Ye toner base particle, and a Bk toner base particle were obtained.

### <External Addition of Toner>

In external addition of toner, the following silica particles O to W, x, and y were used.

Silica particle O (RY50, produced by Nippon Aerosil Co., Ltd.): a raw material was produced by a dry method, and a surface was treated with polydimethyl siloxane (BET: 20.09 m²/g, negative charging properties).

Silica particle P (RY51, produced by Nippon Aerosil Co., Ltd.): a raw material was produced by a dry method, and a surface was treated with polydimethyl siloxane (BET: 16.52 m²/g, negative charging properties).

Silica particle Q (RY40S, produced by Nippon Aerosil Co., Ltd.): a raw material was produced by a dry method, and a surface was treated with polydimethyl siloxane (BET: 18.96 m²/g, negative charging properties).

silica particle R (RX40S, produced by Nippon Aerosil Co., Ltd.): a raw material was produced by a dry method, and a surface was treated with hexamethyl disilazane (BET: 29.89 m²/g, negative charging properties).

Silica particle S (VPSY110, produced by Nippon Aerosil Co., Ltd.): a raw material was produced by a wet method, and a surface was treated with polydimethyl siloxane (BET: 20.09 m²/g, negative charging properties).

Silica particle T (VPSX110, produced by Nippon Aerosil Co., Ltd.): a raw material was produced by a dry method, and a surface was treated with hexamethyl disilazane (BET: 15.22 m²/g, negative charging properties).

Silica particle U (X24-9163A, produced by Shin-Etsu Chemical Co., Ltd.): a raw material was produced by a wet method, and a surface was treated with hexamethyl disilazane (BET: 30.88 m²/g, negative charging properties).

Silica particle V (X24-9600A, produced by Shin-Etsu Chemical Co., Ltd.): a raw material was produced by a wet method, and a surface was treated with hexamethyl disilazane (BET: 34.89 m²/g, negative charging properties).

Silica particle W (TGC-243, produced by Cabot Corporation): a raw material was produced by a wet method, and a surface was treated with octylsilane and hexamethyl disilazane (BET: 44.68 m²/g, negative charging properties)

Silica particle x (RY200L, produced by Nippon Aerosil Co., Ltd.): a raw material was produced by a wet method, and a surface was treated with polydimethyl siloxane (BET: 108. 5 m²/g, negative charging properties).

Silica particle y (H30TD, produced by Wacker Chemical Corporation): a raw material was produced by a dry method, and a surface was treated with polydimethyl siloxane (BET: 147.5 m²/g, negative charging properties).

In the external addition of toner, the following titanium oxides H and I were used.

Titanium oxide H (JMT150AO, produced by TAYCA CORPORATION) (average primary particle size: 15 nm, BET: 97.28 m²/g, charging amount: −33.3 μC/g)

Titanium oxide I (SMT150IB, produced by TAYCA CORPORATION) (average primary particle size: 15 nm, BET: 90.98 m²/g, charging amount: −30.4 μC/g)

### [Production Example of Electrostatic Charge Developing Toner: Cy-1]

The obtained Cy toner base particle and the components indicated in <Formulation Table-7> were stirred and mixed at 3500 rpm for 17 minutes in a Henschel mixer and sieved so as to obtain electrostatic charge developing toner Cy-1.

<Formulation Table-7>

| | | |
|---|---|---|
| Cy toner base particle | 100.0 | parts by mass |
| Silica particle O | 1.70 | parts by mass |
| Silica particle x | 1.20 | parts by mass |
| Titanium oxide H | 0.15 | parts by mass |

### [Production Example of Electrostatic Charge Developing Toner: Cy-2]

A toner Cy-2 was obtained by using the same method as that used in the case of Cy-1 except that the silica particle O was changed to the silica particle Q in the method of producing Cy-1 for electrostatic charge development.

### [Production Example of Electrostatic Charge Developing Toner: Cy-3]

A toner Cy-3 was obtained by using the same method as that used in the case of Cy-1 except that the silica particle O was changed to the silica particle Q, and the amount of titanium oxide H added was set to be 0.00 parts by mass in the method of producing Cy-1 for electrostatic charge development.

### [Production Example of Electrostatic Charge Developing Toner: Cy-4]

A toner Cy-4 was obtained by using the same method as that used in the case of Cy-1 except that the silica particle O was changed to the silica particle P in the method of producing Cy-1 for electrostatic charge development.

### [Production Example of Electrostatic Charge Developing Toner: Cy-5]

A toner Cy-5 was obtained by using the same method as that used in the case of Cy-1 except that the silica particle O was changed to the silica particle Q, and the amount of the silica particle Q added was set to be 1.0 parts by mass in the method of producing Cy-1 for electrostatic charge development.

### [Production Example of Electrostatic Charge Developing Toner: Cy-6]

A toner Cy-6 was obtained by using the same method as that used in the case of Cy-1 except that the amount of the silica particle O added was set to be 0.00 parts by mass, the amount of the silica particle x added was set to be 1.40 parts by mass, and the amount of titanium oxide H added was set to be 0.30 parts by mass in the method of producing Cy-1 for electrostatic charge development.

### [Production Example of Electrostatic Charge Developing Toner: Cy-7]

The obtained Cy toner base particle and the components indicated in <Formulation Table-8> were stirred and mixed at 3500 rpm for 25 minutes in a Henschel mixer and sieved so as to obtain electrostatic charge developing toner Cy-7.

<Formulation Table-8>

| | | |
|---|---|---|
| Cy toner base particle | 100.0 | parts by mass |
| Silica particle Q | 1.70 | parts by mass |
| Silica particle y | 0.60 | parts by mass |
| Titanium oxide I | 0.10 | parts by mass |

### [Production Example of Electrostatic Charge Developing Toner: Cy-8]

A toner Cy-8 was obtained by using the same method as that used in the case of Cy-7 except that the amount of silica particle Q added was set to be 0.00 parts by mass in the method of producing Cy-7 for electrostatic charge development.

### [Production Example of Electrostatic Charge Developing Toner: Cy-9]

A toner Cy-9 was obtained by using the same method as that used in the case of Cy-7 except that the amount of silica particle Q added was set to be 1.00 parts by mass in the method of producing Cy-7 for electrostatic charge development.

### [Production Example of Electrostatic Charge Developing Toner: Cy-10]

A toner Cy-10 was obtained by using the same method as that used in the case of Cy-7 except that the silica particle Q is changed to silica particle S, and the amount of the silica particle S added was set to be 1.00 parts by mass in the method of producing Cy-7 for electrostatic charge development.

### [Production Example of Electrostatic Charge Developing Toner: Cy-11]

A toner Cy-11 was obtained by using the same method as that used in the case of Cy-7 except that the silica particle Q is changed to silica particle U, and the amount of the silica particle U added was set to be 1.00 parts by mass in the method of producing Cy-7 for electrostatic charge development.

### [Production Example of Electrostatic Charge Developing Toner: Cy-12]

A toner Cy-12 was obtained by using the same method as that used in the case of Cy-7 except that the silica particle Q is changed to silica particle V, and the amount of the silica particle V added was set to be 1.00 parts by mass in the method of producing Cy-7 for electrostatic charge development.

### [Production Example of Electrostatic Charge Developing Toner: Cy-13]

A toner Cy-13 was obtained by using the same method as that used in the case of Cy-7 except that the silica particle Q is changed to silica particle W, and the amount of the silica particle W added was set to be 1.00 parts by mass in the method of producing Cy-7 for electrostatic charge development.

### [Production Example of Electrostatic Charge Developing Toner: Cy-14]

A toner Cy-14 was obtained by using the same method as that used in the case of Cy-7 except that the silica particle Q is changed to silica particle R, and the amount of the silica particle R added was set to be 1.00 parts by mass in the method of producing Cy-7 for electrostatic charge development.

### [Production Example of Electrostatic Charge Developing Toner: Cy-15]

A toner Cy-15 was obtained by using the same method as that used in the case of Cy-7 except that the silica particle Q is changed to silica particle T, and the amount of the silica particle T added was set to be 1.00 parts by mass in the method of producing Cy-7 for electrostatic charge development.

### [Production Example of Electrostatic Charge Developing Toner: Ma-1]

The obtained Ma toner base particle and the components indicated in <Formulation Table-9> were stirred and mixed at 3500 rpm for 17 minutes in a Henschel mixer and sieved so as to obtain electrostatic charge developing toner Ma-1.

<Formulation Table-9>

| | | |
|---|---|---|
| Ma toner base particle | 100.0 | parts by mass |
| Silica particle O | 1.70 | parts by mass |
| Silica particle x | 1.20 | parts by mass |
| Titanium oxide H | 0.15 | parts by mass |

### [Production Example of Electrostatic Charge Developing Toner: Ma-2]

A toner Ma-2 was obtained by using the same method as that used in the case of Ma-1 except that the silica particle O was changed to the silica particle Q in the method of producing Ma-1 for electrostatic charge development.

### [Production Example of Electrostatic Charge Developing Toner: Ma-3]

A toner Ma-3 was obtained by using the same method as that used in the case of Ma-1 except that the silica particle O was changed to the silica particle Q, and the amount of titanium oxide H added was set to be 0.00 parts by mass in the method of producing Ma-1 for electrostatic charge development.

### [Production Example of Electrostatic Charge Developing Toner: Ma-4]

A toner Ma-4 was obtained by using the same method as that used in the case of MA-1 except that the silica particle O was changed to the silica particle P in the method of producing MA-1 for electrostatic charge development.

### [Production Example of Electrostatic Charge Developing Toner: Ma-5]

A toner MA-5 was obtained by using the same method as that used in the case of Ma-1 except that the silica particle O was changed to the silica particle Q, and the amount of the silica particle Q added was set to be 1.00 parts by mass in the method of producing Ma-1 for electrostatic charge development.

### [Production Example of Electrostatic Charge Developing Toner: Ma-6]

A toner Ma-6 was obtained by using the same method as that used in the case of Ma-1 except that the amount of the silica particle O added was set to be 0.00 parts by mass, and the amount of the silica particle x added was set to be 1.40 parts by mass in the method of producing Ma-1 for electrostatic charge development.

### [Production Example of Electrostatic Charge Developing Toner: Ma-7]

The obtained Ma toner base particle and the components indicated in <Formulation Table-10> were stirred and mixed at 3500 rpm for 25 minutes in a Henschel mixer and sieved so as to obtain electrostatic charge developing toner MA-7.

<Formulation Table-10>

| | | |
|---|---|---|
| Ma toner base particle | 100.0 | parts by mass |
| Silica particle Q | 1.70 | parts by mass |
| Silica particle y | 0.60 | parts by mass |
| Titanium oxide I | 0.20 | parts by mass |

### [Production Example of Electrostatic Charge Developing Toner: Ma-8]

A toner Ma-8 was obtained by using the same method as that used in the case of Ma-7 except that the amount of silica particle Q added was set to be 0.00 parts by mass in the method of producing Ma-7 for electrostatic charge development.

### [Production Example of Electrostatic Charge Developing Toner: Ma-9]

A toner Ma-9 was obtained by using the same method as that used in the case of Ma-7 except that the amount of silica particle Q added was set to be 1.00 parts by mass in the method of producing Ma-7 for electrostatic charge development.

### [Production Example of Electrostatic Charge Developing Toner: Ma-10]

A toner Ma-10 was obtained by using the same method as that used in the case of Ma-7 except that the silica particle Q is changed to silica particle S, and the amount of the silica particle S added was set to be 1.00 parts by mass in the method of producing Ma-7 for electrostatic charge development.

### [Production Example of Electrostatic Charge Developing Toner: Ma-11]

A toner Ma-11 was obtained by using the same method as that used in the case of Ma-7 except that the silica particle Q is changed to silica particle U, and the amount of the silica particle U added was set to be 1.00 parts by mass in the method of producing Ma-7 for electrostatic charge development.

### [Production Example of Electrostatic Charge Developing Toner: Ma-12]

A toner Ma-12 was obtained by using the same method as that used in the case of Ma-7 except that the silica particle Q is changed to silica particle V, and the amount of the silica particle V added was set to be 1.00 parts by mass in the method of producing Ma-7 for electrostatic charge development.

### [Production Example of Electrostatic Charge Developing Toner: Ma-13]

A toner Ma-13 was obtained by using the same method as that used in the case of Ma-7 except that the silica particle Q is changed to silica particle W, and the amount of the silica particle W added was set to be 1.00 parts by mass in the method of producing Ma-7 for electrostatic charge development.

### [Production Example of Electrostatic Charge Developing Toner: Ma-14]

A toner Ma-14 was obtained by using the same method as that used in the case of Ma-7 except that the silica particle Q is changed to silica particle R, and the amount of the silica particle R added was set to be 1.00 parts by mass in the method of producing Ma-7 for electrostatic charge development.

### [Production Example of Electrostatic Charge Developing Toner: Ma-15]

A toner Ma-15 was obtained by using the same method as that used in the case of Ma-7 except that the silica particle Q is changed to silica particle T, and the amount of the silica particle T added was set to be 1.00 parts by mass in the method of producing Ma-7 for electrostatic charge development.

### [Production Example of Electrostatic Charge Developing Toner: Ye-1]

The obtained Ye toner base particle and the components indicated in <Formulation Table-11> were stirred and mixed at 3500 rpm for 17 minutes in a Henschel mixer and sieved so as to obtain electrostatic charge developing toner Ye-1.

<Formulation Table-11>

| | | |
|---|---|---|
| Ye toner base particle | 100.0 | parts by mass |
| Silica particle O | 1.00 | parts by mass |
| Silica particle x | 1.40 | parts by mass |
| Titanium oxide H | 0.20 | parts by mass |

### [Production Example of Electrostatic Charge Developing Toner: Ye-2]

A toner Ye-2 was obtained by using the same method as that used in the case of Ye-1 except that the silica particle O was changed to the silica particle Q in the method of producing Ye-1 for electrostatic charge development.

### [Production Example of Electrostatic Charge Developing Toner: Ye-3]

A toner Ye-3 was obtained by using the same method as that used in the case of Ye-1 except that the amount of silica particle O added was set to be 0.00 parts by mass, and the amount of silica particle x added was set to be 1.60 parts by mass in the method of producing Ye-1 for electrostatic charge development.

### [Production Example of Electrostatic Charge Developing Toner: Ye-4]

A toner Ye-4 was obtained by using the same method as that used in the case of Ye-1 except that the silica particle O was changed to the silica particle Q, and the amount of the silica particle Q added was set to be 1.70 parts by mass in the method of producing Ye-1 for electrostatic charge development.

### [Production Example of Electrostatic Charge Developing Toner: Ye-5]

A toner Ye-5 was obtained by using the same method as that used in the case of Ye-1 except that the amount of the silica particle O added was set to be 1.70 parts by mass in the method of producing Ye-1 for electrostatic charge development.

### [Production Example of Electrostatic Charge Developing Toner: Ye-6]

The obtained Ye toner base particle and the components indicated in <Formulation Table-12> were stirred and mixed at 3500 rpm for 25 minutes in a Henschel mixer and sieved so as to obtain electrostatic charge developing toner Ye-6.

<Formulation Table-12>

| | | |
|---|---|---|
| Ye toner base particle | 100.0 | parts by mass |
| Silica particle Q | 1.70 | parts by mass |
| Silica particle y | 0.40 | parts by mass |
| Titanium oxide I | 0.20 | parts by mass |

### [Production Example of Electrostatic Charge Developing Toner: Ye-7]

A toner Ye-7 was obtained by using the same method as that used in the case of Ye-6 except that the amount of silica particle Q added was set to be 0.00 parts by mass in the method of producing Ye-6 for electrostatic charge development.

### [Production Example of Electrostatic Charge Developing Toner: Ye-8]

A toner Ye-8 was obtained by using the same method as that used in the case of Ye-6 except that the amount of silica particle Q added was set to be 1.00 parts by mass in the method of producing Ye-6 for electrostatic charge development.

### [Production Example of Electrostatic Charge Developing Toner: Ye-9]

A toner Ye-9 was obtained by using the same method as that used in the case of Ye-6 except that the silica particle Q is changed to silica particle S, and the amount of the silica particle S added was set to be 1.00 parts by mass in the method of producing Ye-6 for electrostatic charge development.

### [Production Example of Electrostatic Charge Developing Toner: Ye-10]

A toner Ye-10 was obtained by using the same method as that used in the case of Ye-6 except that the silica particle Q is changed to silica particle U, and the amount of the silica particle U added was set to be 1.00 parts by mass in the method of producing Ye-6 for electrostatic charge development.

### [Production Example of Electrostatic Charge Developing Toner: Ye-11]

A toner Ye-11 was obtained by using the same method as that used in the case of Ye-6 except that the silica particle Q is changed to silica particle V, and the amount of the silica particle V added was set to be 1.00 parts by mass in the method of producing Ye-6 for electrostatic charge development.

### [Production Example of Electrostatic Charge Developing Toner: Ye-12]

A toner Ye-12 was obtained by using the same method as that used in the case of Ye-6 except that the silica particle Q is changed to silica particle W, and the amount of the silica particle W added was set to be 1.00 parts by mass in the method of producing Ye-6 for electrostatic charge development.

### [Production Example of Electrostatic Charge Developing Toner: Ye-13]

A toner Ye-13 was obtained by using the same method as that used in the case of Ye-6 except that the silica particle Q is changed to silica particle R, and the amount of the silica particle R added was set to be 1.00 parts by mass in the method of producing Ye-6 for electrostatic charge development.

### [Production Example of Electrostatic Charge Developing Toner: Ye-14]

A toner Ye-14 was obtained by using the same method as that used in the case of Ye-6 except that the silica particle Q is changed to silica particle T, and the amount of the silica particle T added was set to be 1.00 parts by mass in the method of producing Ye-6 for electrostatic charge development.

### [Production Example of Electrostatic Charge Developing Toner: Bk-1]

The obtained Bk toner base particle and the components indicated in <Formulation Table-13> were stirred and mixed at 3500 rpm for 17 minutes in a Henschel mixer and sieved so as to obtain electrostatic charge developing toner Bk-1.

<Formulation Table-13>

| | | |
|---|---|---|
| Bk toner base particle | 100.0 | parts by mass |
| Silica particle O | 1.00 | parts by mass |
| Silica particle x | 1.40 | parts by mass |

### [Production Example of Electrostatic Charge Developing Toner: Bk-2]

A toner Bk-2 was obtained by using the same method as that used in the case of Bk-1 except that the silica particle O was changed to the silica particle Q, and the amount of the silica particle x added was set to be 1.70 parts by mass in the method of producing Bk-1 for electrostatic charge development.

### [Production Example of Electrostatic Charge Developing Toner: Bk-3]

A toner Bk-3 was obtained by using the same method as that used in the case of Bk-1 except that the silica particle O was changed to the silica particle Q in the method of producing Bk-1 for electrostatic charge development.

### [Production Example of Electrostatic Charge Developing Toner: Bk-4]

A toner Bk-4 was obtained by using the same method as that used in the case of Bk-1 except that the silica particle O was changed to the silica particle Q, and the amount of the silica particle x added was set to be 1.20 parts by mass in the method of producing Bk-1 for electrostatic charge development.

### [Production Example of Electrostatic Charge Developing Toner: Bk-5]

A toner Bk-5 was obtained by using the same method as that used in the case of Bk-1 except that the silica particle O added was set to be 1.70 parts by mass in the method of producing Bk-1 for electrostatic charge development.

### [Production Example of Electrostatic Charge Developing Toner: Bk-6]

A toner Bk-6 was obtained by using the same method as that used in the case of Bk-1 except that the amount of the silica particle O added was set to be 0.00 parts by mass, and the amount of the silica particle x added was set to be 1.60 parts by mass in the method of producing Bk-1 for electrostatic charge development.

### [Production Example of Electrostatic Charge Developing Toner: Bk-7]

The obtained Bk toner base particle and the components indicated in <Formulation Table-14> were stirred and mixed at 3500 rpm for 25 minutes in a Henschel mixer and sieved so as to obtain electrostatic charge developing toner Bk-7.

<Formulation Table-14>

| | | |
|---|---|---|
| Bk toner base particle | 100.0 | parts by mass |
| Silica particle Q | 1.70 | parts by mass |
| Silica particle y | 0.60 | parts by mass |
| Titanium oxide I | 0.10 | parts by mass |

### [Production Example of Electrostatic Charge Developing Toner: Bk-8]

A toner Bk-8 was obtained by using the same method as that used in the case of Bk-7 except that the amount of silica particle Q added was set to be 0.00 parts by mass in the method of producing Bk-7 for electrostatic charge development.

### [Production Example of Electrostatic Charge Developing Toner: Bk-9]

A toner Bk-9 was obtained by using the same method as that used in the case of Bk-7 except that the amount of silica particle Q added was set to be 1.00 parts by mass in the method of producing Bk-7 for electrostatic charge development.

### [Production Example of Electrostatic Charge Developing Toner: Bk-10]

A toner Bk-10 was obtained by using the same method as that used in the case of Bk-7 except that the silica particle Q is changed to silica particle S, and the amount of the silica particle S added was set to be 1.00 parts by mass in the method of producing Bk-7 for electrostatic charge development.

### [Production Example of Electrostatic Charge Developing Toner: Bk-11]

A toner Bk-11 was obtained by using the same method as that used in the case of Bk-7 except that the silica particle Q is changed to silica particle U, and the amount of the silica particle U added was set to be 1.00 parts by mass in the method of producing Bk-7 for electrostatic charge development.

### [Production Example of Electrostatic Charge Developing Toner: Bk-12]

A toner Bk-12 was obtained by using the same method as that used in the case of Bk-7 except that the silica particle Q is changed to silica particle V, and the amount of the silica particle V added was set to be 1.00 parts by mass in the method of producing Bk-7 for electrostatic charge development.

### [Production Example of Electrostatic Charge Developing Toner: Bk-13]

A toner Bk-13 was obtained by using the same method as that used in the case of Bk-7 except that the silica particle Q is changed to silica particle W, and the amount of the silica particle W added was set to be 1.00 parts by mass in the method of producing Bk-7 for electrostatic charge development.

### [Production Example of Electrostatic Charge Developing Toner: Bk-14]

A toner Bk-14 was obtained by using the same method as that used in the case of Bk-7 except that the silica particle Q is changed to silica particle R, and the amount of the silica particle R added was set to be 1.00 parts by mass in the method of producing Bk-7 for electrostatic charge development.

### [Production Example of Electrostatic Charge Developing Toner: Bk-15]

A toner Bk-15 was obtained by using the same method as that used in the case of Bk-7 except that the silica particle Q is changed to silica particle T, and the amount of the silica particle T added was set to be 1.00 parts by mass in the method of producing Bk-7 for electrostatic charge development.

As described above, the conditions of the external addition step for the toner Cy's 1 to 15, the toner Ma's 1 to 15, the toner Ye's 1 to 14, and the toner Bk's 1 to 15 are specifically indicated in Table 1 and Table 2.

TABLE 1

| | Color | | Cy | Ma | Ye | Bk | | |
|---|---|---|---|---|---|---|---|---|
| | Additives | | | | | | External addition conditions | |
| | Types | BET (m²/g) | Added amount (part by mass) | | | | Rotation frequency (rpm) | Time (minutes) |
| Example 1 | Toner | | Cy-1 | Ma-1 | Ye-1 | BK-1 | 3500 | 17 |
| | RY50 | 20.09 | 1.70 | 1.70 | 1.00 | 1.00 | | |
| | RY200L | 108.50 | 1.20 | 1.20 | 1.40 | 1.40 | | |
| | JMT150AO | 97.28 | 0.15 | 0.15 | 0.20 | 0.00 | | |
| Example 2 | Toner | | Cy-1 | Ma-1 | Ye-2 | BK-2 | 3500 | 17 |
| | RY50 | 20.09 | 1.70 | 1.70 | 0.00 | 0.00 | | |
| | RY40S | 18.96 | 0.00 | 0.00 | 1.00 | 1.00 | | |
| | RY200L | 108.50 | 1.20 | 1.20 | 1.40 | 1.70 | | |
| | JMT150AO | 97.28 | 0.15 | 0.15 | 0.20 | 0.00 | | |
| Example 3 | Toner | | Cy-2 | Ma-2 | Ye-2 | BK-3 | 3500 | 17 |
| | RY40S | 18.96 | 1.70 | 1.70 | 1.00 | 1.00 | | |
| | RY200L | 108.50 | 1.20 | 1.20 | 1.40 | 1.40 | | |
| | JMT150AO | 97.28 | 0.15 | 0.15 | 0.20 | 0.00 | | |
| Example 4 | Toner | | Cy-2 | Ma-2 | Ye-2 | BK-3 | 3500 | 17 |
| | RY40S | 18.96 | 1.70 | 1.70 | 1.00 | 1.00 | | |
| | RY200L | 108.50 | 1.20 | 1.20 | 1.40 | 1.40 | | |
| | JMT150AO | 97.28 | 0.15 | 0.15 | 0.20 | 0.00 | | |
| Example 5 | Toner | | Cy-7 | Ma-7 | Ye-6 | BK-7 | 3500 | 25 |
| | RY40S | 18.96 | 1.70 | 1.70 | 1.70 | 1.70 | | |
| | H30TD | 147.50 | 0.60 | 0.60 | 0.40 | 0.60 | | |
| | SMT150IB | 90.98 | 0.10 | 0.20 | 0.20 | 0.10 | | |
| Comparative | Toner | | Cy-3 | Ma-3 | Ye-4 | BK-4 | 3500 | 17 |
| Example 1 | RY40S | 18.96 | 1.70 | 1.70 | 1.70 | 1.00 | | |
| | RY200L | 108.50 | 1.20 | 1.20 | 1.40 | 1.20 | | |
| | JMT150AO | 97.28 | 0.00 | 0.00 | 0.20 | 0.00 | | |
| Comparative | Toner | | Cy-4 | Ma-4 | Ye-5 | BK-5 | 3500 | 17 |
| Example 2 | RY51 | 16.52 | 1.70 | 1.70 | 0.00 | 0.00 | | |
| | RY50 | 20.09 | 0.00 | 0.00 | 1.70 | 1.70 | | |
| | RY200L | 108.50 | 1.20 | 1.20 | 1.40 | 1.40 | | |
| | JMT150AO | 97.28 | 0.15 | 0.15 | 0.20 | 0.00 | | |
| Comparative | Toner | | Cy-5 | Ma-5 | Ye-3 | BK-3 | 3500 | 17 |
| Example 3 | RY40S | 18.96 | 1.00 | 1.00 | 0.00 | 1.00 | | |
| | RY200L | 108.50 | 1.20 | 1.20 | 1.60 | 1.40 | | |
| | JMT150AO | 97.28 | 0.15 | 0.15 | 0.20 | 0.00 | | |
| Comparative | Toner | | Cy-8 | Ma-8 | Ye-7 | BK-8 | 3500 | 25 |
| Example 4 | RY40S | 18.96 | 0.00 | 0.00 | 0.00 | 0.00 | | |
| | H30TD | 147.50 | 0.60 | 0.60 | 0.40 | 0.60 | | |
| | SMT150IB | 90.98 | 0.10 | 0.20 | 0.20 | 0.10 | | |

TABLE 2

| | Color | | Cy | Ma | Ye | Bk | | |
|---|---|---|---|---|---|---|---|---|
| | Additives | | | | | | External addition conditions | |
| | Types | BET (m²/g) | Added amount (part by mass) | | | | Rotation frequency (rpm) | Time (minutes) |
| Comparative | Toner | | Cy-6 | Ma-6 | Ye-3 | BK-6 | 3500 | 17 |
| Example 5 | RY50 | 20.09 | 0.00 | 0.00 | 0.00 | 0.00 | | |
| | RY200L | 108.50 | 1.40 | 1.40 | 1.60 | 1.60 | | |
| | JMT150AO | 97.28 | 0.30 | 0.15 | 0.20 | 0.00 | | |
| Comparative | Toner | | Cy-9 | Ma-9 | Ye-8 | BK-9 | 3500 | 25 |
| Example 6 | RY40S | 18.96 | 1.00 | 1.00 | 1.00 | 1.00 | | |
| | H30TD | 147.50 | 0.60 | 0.60 | 0.40 | 0.60 | | |
| | SMT150IB | 90.98 | 0.10 | 0.20 | 0.20 | 0.10 | | |
| Comparative | Toner | | Cy-10 | Ma-10 | Ye-9 | BK-10 | 3500 | 25 |
| Example 7 | VPSY110 | 20.09 | 1.00 | 1.00 | 1.00 | 1.00 | | |
| | H30TD | 147.50 | 0.60 | 0.60 | 0.40 | 0.60 | | |
| | SMT150IB | 90.98 | 0.10 | 0.20 | 0.20 | 0.10 | | |
| Comparative | Toner | | Cy-11 | Ma-11 | Ye-10 | BK-11 | 3500 | 25 |
| Example 8 | X24-9163A | 30.88 | 1.00 | 1.00 | 1.00 | 1.00 | | |
| | H30TD | 147.50 | 0.60 | 0.60 | 0.40 | 0.60 | | |
| | SMT150IB | 90.98 | 0.10 | 0.20 | 0.20 | 0.10 | | |
| Comparative | Toner | | Cy-12 | Ma-12 | Ye-11 | BK-12 | 3500 | 25 |
| Example 9 | X24(9600A-100) | 34.89 | 1.00 | 1.00 | 1.00 | 1.00 | | |
| | H30TD | 147.50 | 0.60 | 0.60 | 0.40 | 0.60 | | |
| | SMT150IB | 90.98 | 0.10 | 0.20 | 0.20 | 0.10 | | |
| Comparative | Toner | | Cy-13 | Ma-13 | Ye-12 | BK-13 | 3500 | 25 |
| Example 10 | TGC-243 | 44.68 | 1.00 | 1.00 | 1.00 | 1.00 | | |
| | H30TD | 147.50 | 0.60 | 0.60 | 0.40 | 0.60 | | |
| | SMT150IB | 90.98 | 0.10 | 0.20 | 0.20 | 0.10 | | |
| Comparative | Toner | | Cy-14 | Ma-14 | Ye-13 | BK-14 | 3500 | 25 |
| Example 11 | RX40S | 29.89 | 1.00 | 1.00 | 1.00 | 1.00 | | |
| | H30TD | 147.50 | 0.60 | 0.60 | 0.40 | 0.60 | | |
| | SMT150IB | 90.98 | 0.10 | 0.20 | 0.20 | 0.10 | | |
| Comparative | Toner | | Cy-15 | Ma-15 | Ye-14 | BK-15 | 3500 | 25 |
| Example 12 | VPSX110 | 15.22 | 1.00 | 1.00 | 1.00 | 1.00 | | |
| | H30TD | 147.50 | 0.60 | 0.60 | 0.40 | 0.60 | | |
| | SMT150IB | 90.98 | 0.10 | 0.20 | 0.20 | 0.10 | | |

### [Combinations of Toners of Four Colors Used in Examples and Comparative Examples]

Combinations of toners of four colors used in Examples 1 to 5, and Comparative Examples 1 to 12 and live-action results are specifically indicated in Table 3 and Table 4.

### <Evaluation Method>

Regarding the obtained toner, live-action evaluation on the following items was performed.

1. Presence or absence of image defect by cleaning problem toner on transfer material transporting belt
2. Image density and standard deviation of image density
3. Toner consumption

Evaluation results of the above 1 to 3 are indicated in Table 3 and Table 4.

<Evaluation Method>

The obtained toner was subjected to image quality evaluation by a live-action test. In the live-action test, a full-color printer was used with roller charging, a rubber developing roller contact developing method, a tandem method, a direct transfer method, a thermal fixing method, and a blade drum cleaning method at process speed 135 mm/s, by using a non-magnetic one component and organic photoreceptor (OPC).

After printing several sheets under the environment of 23° C. and 50%, a total of 12,000 charts were printed at a printing rate of 5%. In the 12,000 sheets of printing, the following items were determined for printing before long-term printing (at an initial stage) and for every 4000 sheets of printing.

### <Cleaning Properties of Transfer Material Transporting Belt>

The criteria for determining the cleaning properties of toner on the transfer material transporting belt are as follows.

When the long-term printing up to 4,000 sheets from the initial stage is set as an early stage, the long-term printing up to 8,000 sheets from 4,000 sheets is set as a middle stage, and the long-term printing up to 12,000 sheets from 8,000 sheets is set as an end stage,

A: None of image defect
B: Minor image defects are recognized, but there is no problem in practical use
C: Obvious image defects are recognized, which causes problems in practical use

According to the above criteria, the cleaning problem of the toner on the transfer material transporting belt was determined comprehensively as follows.

AA: Two or more AA through initial stage, end stage, and middle stage
A: One or more A through initial stage, end stage, and middle stage
B: B all through initial stage, end stage, and middle stage (including a case where the long-term printing is finished at the middle stage)
C: One or more C through initial stage, end stage, and middle stage

### <Image Density and Standard Deviation of Image Density>

For measurement of image density, the measurement was performed by using a spectral densitometer 500 series (manufactured by X-Rite Co., Ltd.) with a viewing angle of 10° and an observation condition of F2.

The criteria are as follows.
Image density (average value of measurement values for printing at initial stage and every 4,000 sheets of printing)
AA: Average value of image density for four colors is equal to or greater than 1.25
A: Average value of image density for four colors is equal to or greater than 1.15 and less than 1.25
B: Average value of image density for four colors is less than 1.15
Standard deviation of image density (measurement values for printing at initial stage and every 4,000 sheets of printing)
A: Standard deviation of image density for four colors is less than 0.10
B: Standard deviation of image density for four colors is equal to or greater than 0.10 and less than 0.15
C: Standard deviation of image density for four colors is equal to or greater than 0.15

### <Toner Consumption>

Criteria of toner consumption are as follows.

AA: Average toner consumption converted per 1,000 sheets is less than 14.0 g
A: Average toner consumption converted per 1,000 sheets is equal to or greater than 14.0 g and less than 16.0 g
B: Average toner consumption converted per 1,000 sheets is equal to or greater than 16.0 g

TABLE 3

| | | | Additives | | | | | | | | | | | | |
|---|---|---|---|---|---|---|---|---|---|---|---|---|---|---|---|
| | | | Silica (a) | | | | | Silica (b) | | | Titanium oxide | | | Silica (a) + Silica (b) | |
| | | | | Core | Surface | | Part | | | Part | | | Part | Mono- | Total of |
| | Base | | | production | treat- | BET | by | | BET | by | | BET | by | chrome | four colors |
| | particle | Toner | Types | method | ment | (m²/g) | mass | Types | (m²/g) | mass | Types | (m²/g) | mass | Part by mass | Part by mass |
| Example 1 | Cy | Cy-1 | O | Dry method | PDMS | 20.09 | 1.70 | x | 108.5 | 1.20 | H | 97.28 | 0.15 | 2.90 | 10.60 |
| | Ma | Ma-1 | O | Dry method | PDMS | 20.09 | 1.70 | x | 108.5 | 1.20 | H | 97.28 | 0.15 | 2.90 | |
| | Ye | Ye-1 | O | Dry method | PDMS | 20.09 | 1.00 | x | 108.5 | 1.40 | H | 97.28 | 0.20 | 2.40 | |
| | Bk | BK-1 | O | Dry method | PDMS | 20.09 | 1.00 | x | 108.5 | 1.40 | H | 97.28 | 0.00 | 2.40 | |
| Example 2 | Cy | Cy-1 | O | Dry method | PDMS | 20.09 | 1.70 | x | 108.5 | 1.20 | H | 97.28 | 0.15 | 2.90 | 10.90 |
| | Ma | Ma-1 | O | Dry method | PDMS | 20.09 | 1.70 | x | 108.5 | 1.20 | H | 97.28 | 0.15 | 2.90 | |
| | Ye | Ye-2 | Q | Dry method | PDMS | 18.96 | 1.00 | x | 108.5 | 1.40 | H | 97.28 | 0.20 | 2.40 | |
| | Bk | BK-2 | Q | Dry method | PDMS | 18.96 | 1.00 | x | 108.5 | 1.70 | H | 97.28 | 0.00 | 2.70 | |
| Example 3 | Cy | Cy-2 | Q | Dry method | PDMS | 18.96 | 1.70 | x | 108.5 | 1.20 | H | 97.28 | 0.15 | 2.90 | 10.60 |
| | Ma | Ma-2 | Q | Dry method | PDMS | 18.96 | 1.70 | x | 108.5 | 1.20 | H | 97.28 | 0.15 | 2.90 | |
| | Ye | Ye-2 | Q | Dry method | PDMS | 18.96 | 1.00 | x | 108.5 | 1.40 | H | 97.28 | 0.20 | 2.40 | |
| | Bk | BK-3 | Q | Dry method | PDMS | 18.96 | 1.00 | x | 108.5 | 1.40 | H | 97.28 | 0.00 | 2.40 | |
| Example 4 | Cy | Cy-2 | Q | Dry method | PDMS | 18.96 | 1.70 | x | 108.5 | 1.20 | H | 97.28 | 0.15 | 2.90 | 10.50 |
| | Ma | Ma-2 | Q | Dry method | PDMS | 18.96 | 1.70 | x | 108.5 | 1.20 | H | 97.28 | 0.15 | 2.90 | |
| | Ye | Ye-2 | Q | Dry method | PDMS | 18.96 | 1.00 | x | 108.5 | 1.40 | H | 97.28 | 0.20 | 2.40 | |
| | Bk | BK-3 | Q | Dry method | PDMS | 18.96 | 1.00 | x | 108.5 | 1.40 | H | 97.28 | 0.00 | 2.40 | |
| Example 5 | Cy | Cy-7 | Q | Dry method | PDMS | 18.96 | 1.70 | x | 147.5 | 0.60 | I | 90.98 | 0.10 | 2.30 | 9.00 |
| | Ma | Ma-7 | Q | Dry method | PDMS | 18.96 | 1.70 | x | 147.5 | 0.60 | I | 90.98 | 0.20 | 2.30 | |
| | Ye | Ye-6 | Q | Dry method | PDMS | 18.96 | 1.70 | x | 147.5 | 0.40 | I | 90.98 | 0.20 | 2.10 | |
| | Bk | BK-7 | Q | Dry method | PDMS | 18.96 | 1.70 | x | 147.5 | 0.60 | I | 90.98 | 0.10 | 2.30 | |
| Com- | Cy | Cy-3 | Q | Dry method | PDMS | 18.96 | 1.70 | x | 108.5 | 1.20 | H | 97.28 | 0.00 | 2.90 | 11.10 |
| parative | Ma | Ma-3 | Q | Dry method | PDMS | 18.96 | 1.70 | x | 108.5 | 1.20 | H | 97.28 | 0.00 | 2.90 | |
| Example 1 | Ye | Ye-4 | Q | Dry method | PDMS | 18.96 | 1.70 | x | 108.5 | 1.40 | H | 97.28 | 0.20 | 3.10 | |
| | Bk | BK-4 | Q | Dry method | PDMS | 18.96 | 1.00 | x | 108.5 | 1.20 | H | 97.28 | 0.00 | 2.20 | |
| Com- | Cy | Cy-4 | P | Dry method | PDMS | 16.52 | 1.70 | x | 108.5 | 1.20 | H | 97.28 | 0.15 | 2.90 | 12.00 |
| parative | Ma | Ma-4 | P | Dry method | PDMS | 16.52 | 1.70 | x | 108.5 | 1.20 | H | 97.28 | 0.15 | 2.90 | |
| Example 2 | Ye | Ye-5 | O | Dry method | PDMS | 20.09 | 1.70 | x | 108.5 | 1.40 | H | 97.28 | 0.20 | 3.10 | |
| | Bk | BK-5 | O | Dry method | PDMS | 20.09 | 1.70 | x | 108.5 | 1.40 | H | 97.28 | 0.00 | 3.10 | |
| Com- | Cy | Cy-5 | Q | Dry method | PDMS | 18.96 | 1.00 | x | 108.5 | 1.20 | H | 97.28 | 0.15 | 2.20 | 8.40 |
| parative | Ma | Ma-5 | Q | Dry method | PDMS | 18.96 | 1.00 | x | 108.5 | 1.20 | H | 97.28 | 0.15 | 2.20 | |
| Example 3 | Ye | Ye-3 | | | | | 0.00 | x | 108.5 | 1.80 | H | 97.28 | 0.20 | 1.60 | |
| | Bk | BK-3 | Q | Dry method | PDMS | 18.96 | 1.00 | x | 108.5 | 1.40 | H | 97.28 | 0.00 | 2.40 | |

| | Live-action test | | | | | | | | | |
|---|---|---|---|---|---|---|---|---|---|---|
| | CL properties | | | | Image density | | | | | |
| | Total | | | | (four colors) | | | | Consumption (average | |
| | deter- | Initial | Middle | End | Average | | Standard | | value of four colors) | |
| | mination | stage | stage | stage | value | | difference | | (g/kp) | |
| Example 1 | AA | A | A | A | 1.34 | AA | 0.08 | A | 15.8 | A |
| Example 2 | A | A | B | B | 1.24 | A | 0.12 | B | 15.2 | A |
| Example 3 | B | B | B | B | 1.19 | A | 0.05 | A | 14.2 | A |
| Example 4 | AA | A | B | A | 1.19 | A | 0.09 | A | 15.2 | A |
| Example 5 | A | A | B | B | 1.13 | B | 0.14 | B | 14.0 | A |
| Com- | C | B | B | C | 1.21 | A | 0.21 | C | 14.4 | A |
| parative | | | | | | | | | | |
| Example 1 | | | | | | | | | | |
| Com- | B | B | B | B | 1.21 | A | 0.17 | C | 13.6 | AA |
| parative | | | | | | | | | | |
| Example 2 | | | | | | | | | | |
| Com- | C | C | C | C | 1.34 | AA | 0.09 | A | 14.0 | A |
| parative | | | | | | | | | | |
| Example 3 | | | | | | | | | | |

TABLE 4

| | | | Additives | | | | | | | | | | | | |
|---|---|---|---|---|---|---|---|---|---|---|---|---|---|---|---|
| | | | Silica (a) | | | | | Silica (b) | | | Titanium oxide | | | Silica (a) + Silica (b) | |
| | Base | | | Core | Surface | | Part | | | Part | | | Part | Monochrome | Total of |
| | par- | | | production | treat- | BET | by | | BET | by | | BET | by | Part by | four colors |
| | ticle | Toner | Types | method | ment | (m²/g) | mass | Types | (m²/g) | mass | Types | (m²/g) | mass | mass | Part by mass |
| Comparative | Cy | Cy-8 | | | | | 0.00 | y | 147.5 | 0.60 | I | 90.98 | 0.10 | 0.60 | 2.20 |
| Example 4 | Ma | Ma-8 | | | | | 0.00 | y | 147.5 | 0.60 | I | 90.98 | 0.20 | 0.60 | |
| | Ye | Ye-7 | | | | | 0.00 | y | 147.5 | 0.40 | I | 90.98 | 0.20 | 0.40 | |
| | Bk | BK-8 | | | | | 0.00 | y | 147.5 | 0.60 | I | 90.98 | 0.10 | 0.60 | |
| Comparative | Cy | Cy-6 | | | | | 0.00 | x | 108.5 | 1.40 | H | 97.28 | 0.30 | 1.40 | 6.00 |
| Example 5 | Ma | Ma-6 | | | | | 0.00 | x | 108.5 | 1.40 | H | 97.28 | 0.15 | 1.40 | |
| | Ye | Ye-3 | | | | | 0.00 | x | 108.5 | 1.60 | H | 97.28 | 0.20 | 1.60 | |
| | Bk | BK-6 | | | | | 0.00 | x | 108.5 | 1.60 | H | 97.28 | 0.00 | 1.60 | |
| Comparative | Cy | Cy-9 | Q | Dry method | PDMS | 18.96 | 1.00 | y | 147.5 | 0.60 | I | 90.98 | 0.10 | 1.60 | 6.20 |
| Example 6 | Ma | Ma-9 | Q | Dry method | PDMS | 18.96 | 1.00 | y | 147.5 | 0.60 | I | 90.98 | 0.20 | 1.60 | |
| | Ye | Ye-8 | Q | Dry method | PDMS | 18.96 | 1.00 | y | 147.5 | 0.40 | I | 90.98 | 0.20 | 1.40 | |
| | Bk | BK-9 | Q | Dry method | PDMS | 18.96 | 1.00 | y | 147.5 | 0.60 | I | 90.98 | 0.10 | 1.60 | |
| Comparative | Cy | Cy-10 | S | Wet method | PDMS | 20.09 | 1.00 | y | 147.5 | 0.60 | I | 90.98 | 0.10 | 1.60 | 6.20 |
| Example 7 | Ma | Ma-10 | S | Wet method | PDMS | 20.09 | 1.00 | y | 147.5 | 0.60 | I | 90.98 | 0.20 | 1.60 | |
| | Ye | Ye-9 | S | Wet method | PDMS | 20.09 | 1.00 | y | 147.5 | 0.40 | I | 90.98 | 0.20 | 1.40 | |
| | Bk | BK-10 | S | Wet method | PDMS | 20.09 | 1.00 | y | 147.5 | 0.60 | I | 90.98 | 0.10 | 1.60 | |
| Comparative | Cy | Cy-11 | U | Wet method | HMDS | 30.88 | 1.00 | y | 147.5 | 0.60 | I | 90.98 | 0.10 | 1.60 | 6.20 |
| Example 8 | Ma | Ma-11 | U | Wet method | HMDS | 30.88 | 1.00 | y | 147.5 | 0.60 | I | 90.98 | 0.20 | 1.60 | |
| | Ye | Ye-10 | U | Wet method | HMDS | 30.88 | 1.00 | y | 147.5 | 0.40 | I | 90.98 | 0.20 | 1.40 | |
| | Bk | BK-11 | U | Wet method | HMDS | 30.88 | 1.00 | y | 147.5 | 0.60 | I | 90.98 | 0.10 | 1.60 | |
| Comparative | Cy | Cy-12 | V | Wet method | HMDS | 34.89 | 1.00 | y | 147.5 | 0.60 | I | 90.98 | 0.10 | 1.60 | 6.20 |
| Example 9 | Ma | Ma-12 | V | Wet method | HMDS | 34.89 | 1.00 | y | 147.5 | 0.60 | I | 90.98 | 0.20 | 1.60 | |
| | Ye | Ye-11 | V | Wet method | HMDS | 34.89 | 1.00 | y | 147.5 | 0.40 | I | 90.98 | 0.20 | 1.40 | |
| | Bk | BK-12 | V | Wet method | HMDS | 34.89 | 1.00 | y | 147.5 | 0.60 | I | 90.98 | 0.10 | 1.60 | |
| Comparative | Cy | Cy-13 | W | Wet method | OTES/ | 44.68 | 1.00 | y | 147.5 | 0.60 | I | 90.98 | 0.10 | 1.60 | 6.20 |
| Example 10 | | | | | HMDS | | | | | | | | | | |
| | Ma | Ma-13 | W | Wet method | OTES/ | 44.68 | 1.00 | y | 147.5 | 0.60 | I | 90.98 | 0.20 | 1.60 | |
| | | | | | HMDS | | | | | | | | | | |
| | Ye | Ye-12 | W | Wet method | OTES/ | 44.68 | 1.00 | y | 147.5 | 0.40 | I | 90.98 | 0.20 | 1.40 | |
| | | | | | HMDS | | | | | | | | | | |
| | Bk | BK-13 | W | Wet method | OTES/ | 44.68 | 1.00 | y | 147.5 | 0.60 | I | 90.98 | 0.10 | 1.60 | |
| | | | | | HMDS | | | | | | | | | | |
| Comparative | Cy | Cy-14 | R | Dry method | HMDS | 29.89 | 1.00 | y | 147.5 | 0.60 | I | 90.98 | 0.10 | 1.60 | 6.20 |
| Example 11 | Ma | Ma-14 | R | Dry method | HMDS | 29.89 | 1.00 | y | 147.5 | 0.60 | I | 90.98 | 0.20 | 1.60 | |
| | Ye | Ye-13 | R | Dry method | HMDS | 29.89 | 1.00 | y | 147.5 | 0.40 | I | 90.98 | 0.20 | 1.40 | |
| | Bk | BK-14 | R | Dry method | HMDS | 29.89 | 1.00 | y | 147.5 | 0.60 | I | 90.98 | 0.10 | 1.60 | |
| Comparative | Cy | Cy-15 | T | Wet method | HMDS | 15.22 | 1.00 | y | 147.5 | 0.60 | I | 90.98 | 0.10 | 1.60 | 6.20 |
| Example 12 | Ma | Ma-15 | T | Wet method | HMDS | 15.22 | 1.00 | y | 147.5 | 0.60 | I | 90.98 | 0.20 | 1.60 | |
| | Ye | Ye-14 | T | Wet method | HMDS | 15.22 | 1.00 | y | 147.5 | 0.40 | I | 90.98 | 0.20 | 1.40 | |
| | Bk | BK-15 | T | Wet method | HMDS | 15.22 | 1.00 | y | 147.5 | 0.60 | I | 90.98 | 0.10 | 1.60 | |

| | Live-action test | | | | | | | | | |
|---|---|---|---|---|---|---|---|---|---|---|
| | CL properties | | | | Image density (four colors) | | | | Consumption (average value | |
| | Total | Initial | Middle | End | Average | | Standard | | of four colors) | |
| | determination | stage | stage | stage | value | | difference | | (g/kp) | |
| Comparative | C | C | C | C | 1.30 | AA | 0.14 | B | 15.4 | A |
| Example 4 | | | | | | | | | | |
| Comparative | C | C | C | — | 1.47 | AA | 0.04 | A | 15.7 | A |
| Example 5 | | | | | | | | | | |
| Comparative | C | B | B | C | 1.19 | A | 0.19 | C | 14.6 | A |
| Example 6 | | | | | | | | | | |
| Comparative | C | B | C | C | 1.09 | B | 0.20 | C | 17.9 | B |
| Example 7 | | | | | | | | | | |
| Comparative | C | C | C | C | 1.14 | B | 0.06 | A | 15.6 | A |
| Example 8 | | | | | | | | | | |
| Comparative | C | C | C | C | 1.17 | A | 0.16 | C | 14.2 | A |
| Example 9 | | | | | | | | | | |
| Comparative | C | C | C | — | 1.11 | B | 0.12 | B | 17.8 | B |
| Example 10 | | | | | | | | | | |
| Comparative | C | C | C | C | 1.17 | A | 0.16 | C | 14.6 | A |
| Example 11 | | | | | | | | | | |
| Comparative | C | C | C | C | 1.13 | B | 0.18 | C | 16.6 | B |
| Example 12 | | | | | | | | | | |

As a result, in Examples, there was no defective cleaning of the transfer material transporting belt, the image density was good and the toner consumption was excellent. On the other hand, in Comparative Examples, the performance was inferior to the example in any of the cleaning property of the transfer material transporting belt, the image density, and the toner consumption amount.

Although the present invention has been described in detail using specific embodiments, it will be apparent to those skilled in the art that various modifications and variations are possible without departing from the spirit and scope of the invention. This application is based on a Japanese patent application (Japanese Patent Application No. 2015-069288) filed on Mar. 30, 2015, the entirety of which is incorporated by reference.

### REFERENCE SIGNS LIST

1 . . . transfer material transporting body
2 . . . cleaning blade for transfer material transporting body
3 . . . electrophotographic cartridge
4 . . . exposure device
5 . . . transfer device
6 . . . fixing device
61 . . . upper fixing member
62 . . . lower fixing member
31 . . . electrophotographic photoreceptor
32 . . . cleaning blade for photoreceptor
33 . . . charging device
34 . . . developing device
35 . . . transfer device
341 . . . developing vessel
342 . . . agitator
343 . . . feed roller
344 . . . developing roller
345 . . . control member

1. An image forming method comprising:
a developing step of using an electrophotographic cartridge equipped with an electrophotographic photoreceptor and toner for developing an electrostatic charge image, and carrying a toner image on the electrophotographic photoreceptor with an electrostatic latent image;
a transfer step of transferring the toner image on the electrophotographic photoreceptor to a transfer material transporting body;
a fixing step of fixing the toner image transferred on the transfer material transporting body to a recording medium; and
a cleaning step of removing the toner remaining in the transfer step from the surface of the transfer material transporting body by a cleaning member for a transfer material transporting body,
wherein the electrophotographic cartridge is disposed in at least four-color tandem with respect to the transfer material transporting body, and
in the transfer step, in a case where the fixing step side of the transfer material transporting body is set as a downstream side, and the cleaning step side of the transfer material transporting body is set as an upstream side, and the electrophotographic cartridge disposed in the four-color tandem satisfies the following (A) to (C):
(A) each color toner provided in an electrophotographic cartridge disposed in a four-color tandem is toner comprising: toner base particles which contain at least a binder resin, a coloring agent and wax; and an external additive, and the toner contains silica particles as the external additive,
(B) the total of four colors of the content of the silica particles contained in each color toner is in a range of 9.0 parts by mass to 12.0 parts by mass with respect to 100 parts by mass of the toner base particles, and the content of the silica particles contained in each color toner is not all the same in four colors, and
(C) the total content of the silica particles in the toner provided in an electrophotographic cartridge disposed on the most downstream side in the transfer step is in a range of 2.3 parts by mass to 3.0 parts by mass with respect to 100 parts by mass of the toner base particles.

2. The image forming method according to claim 1, wherein in the (A), the toner contains silica particles a having a specific surface area in a range of 10 m²/g to 45 m²/g and silica particles b having a specific surface area in a range of 100 m²/g to 160 m²/g.

3. The image forming method according to claim 1, wherein the content of the silica particles in the toner provided in an electrophotographic cartridge disposed on the most downstream side is smaller than the content of the silica particles in the each color toner provided in at least two-color of electrophotographic cartridges other than the electrophotographic cartridge disposed on the most downstream side.

4. The image forming method according to claim 1, wherein the content of the silica particles in the toner provided in an electrophotographic cartridge disposed on the most downstream side is smallest, compared with the content of the silica particles in the each color toner provided in the electrophotographic cartridges other than the electrophotographic cartridge disposed on the most downstream side.

5. The image forming method according to claim 1, wherein a ratio of the content X of the silica particles in the toner provided in an electrophotographic cartridge disposed on the most downstream side and the total sum of content Y of the silica particles in the each color toner provided in the electrophotographic cartridges other than the electrophotographic cartridge disposed on the most downstream side (X/Y) is 0.250 to 0.330.

6. The image forming method according to claim 2, wherein the silica particles a are surface-treated with polydimethyl siloxane.

7. The image forming method according to claim 2, wherein the silica particles a before being surface-treated are dry silica particles.

8. The image forming method according to claim 2, wherein each toner provided in an electrophotographic cartridge other than the electrophotographic cartridge disposed on the most downstream side in the transfer step, contains the silica particles a in a range of 0.50 parts by mass to 2.0 parts by mass, and the silica particles b in a range of 0.20 parts by mass to 2.0 parts by mass, with respect to 100 parts by mass of the toner base particles.
